(19) United States
(12) Patent Application Publication
(10) Pub. No.: US 2024/0311135 A1
(43) Pub. Date: Sep. 19, 2024

(54) CENTER DEVICE AND CAMPAIGN INFORMATION DISTRIBUTION METHOD

(71) Applicant: DENSO CORPORATION, Kariya-city (JP)

(72) Inventors: Hideo YOSHIMI, Kariya-city (JP); Yuzo HARATA, Kariya-city (JP); Nao KOJIMA, Kariya-city (JP); Kazuhiro UEHARA, Kariya-city (JP); Yoshitaka OZAKI, Kariya-city (JP); Shuhei TAKAHASHI, Kariya-city (JP); Masaaki ABE, Kariya-city (JP); Koto TOMATSU, Kariya-city (JP)

(21) Appl. No.: 18/675,823

(22) Filed: May 28, 2024

Related U.S. Application Data
(63) Continuation-in-part of application No. PCT/JP2022/040169, filed on Oct. 27, 2022.

(30) Foreign Application Priority Data
Nov. 30, 2021 (JP) 2021-194285

(51) Int. Cl. G06F 8/65

(52) U.S. Cl. CPC G06F 8/65

(57) ABSTRACT

A center device that manages data to be written in an electronic control device and performs, by an application program, functions to transmit update data to a vehicle by wireless communication is provided. An application program implementing at least one of the functions adopts a serverless architecture. The application program is activated upon occurrence of an event and is dynamically allocated with a resource in an on-demand manner for execution of a code of the application program. The resource is released when the execution of the code is terminated. The center device is configured to receive vehicle configuration information and determine whether there is campaign information; generate campaign notification information; manage a generation state of the campaign notification information; and distribute the campaign notification information.

### CROSS REFERENCE TO RELATED APPLICATIONS

The present application is a continuation-in-part application of International Patent Application No. PCT/JP2022/040169 filed on Oct. 27, 2022, which designated the U.S. and claims the benefit of priority from Japanese Patent Application No. 2021-194285 filed on Nov. 30, 2021. The entire disclosures of all of the above applications are incorporated herein by reference.

### TECHNICAL FIELD

The present disclosure relates to a center device configured to manage data to be written in electronic control device mounted on a vehicle, and a method of distributing campaign information to the vehicle.

### BACKGROUND

A related art discloses a technique in which an update program of an ECU is distributed from a server to an in-vehicle device by Over The Air (OTA), and the update program is rewritten on the vehicle side.

### SUMMARY

A center device that manages data to be written in an electronic control device and performs, by an application program, functions to transmit update data to a vehicle by wireless communication is provided. An application program implementing at least one of the functions adopts a serverless architecture. The application program is activated upon occurrence of an event and is dynamically allocated with a resource in an on-demand manner for execution of a code of the application program. The resource is released when the execution of the code is terminated. The center device is configured to receive vehicle configuration information and determine whether there is campaign information; generate campaign notification information; manage a generation state of the campaign notification information; and distribute the campaign notification information.

### BRIEF DESCRIPTION OF DRAWINGS

The above and other objects, features and advantages of the present disclosure will become more apparent from the following detailed description made with reference to the accompanying drawings. In the drawings:

FIG. 1 is a functional block diagram illustrating a configuration of an OTA center in the first embodiment;

FIG. 2 is a diagram illustrating an example in which the functions of the OTA center are implemented by applying the AWS;

FIG. 3 is a flowchart schematically illustrating processing performed between a vehicle-side system and an OTA center;

FIG. 4A is a flowchart (part 1) illustrating processing from reception of vehicle configuration information to transmission of campaign notification information;

FIG. 4B is a flowchart (part 2) illustrating processing from reception of vehicle configuration information to transmission of campaign notification information;

FIG. 5A is a flowchart (part 1) illustrating processing from registration of campaign information to registration of a distribution package to a CDN distribution section;

FIG. 5B is a flowchart (part 2) illustrating processing from registration of campaign information to registration of a distribution package to a CDN distribution section;

FIG. 6 is a flowchart illustrating processing from data access by the vehicle to distribution of a package by the CDN distribution section;

FIG. 7 is a flowchart illustrating a software update data registration process;

FIG. 8A is a flowchart (part 1) illustrating processing from registration of case information to generation of a package;

FIG. 8B is a flowchart (part 2) illustrating processing from registration of case information to generation of a package;

FIG. 9 is a flowchart (part 3) illustrating processing from registration of case information to generation of a package;

FIG. 10 is a diagram for describing an effect obtained by accumulating data in a queuing buffer section for a certain period of time and then passing the data to a next-stage compute service function section;

FIG. 11 is a view illustrating a processing form of each of a server model and a serverless model;

FIG. 12 is a diagram illustrating running costs of the server model and the serverless model;

FIG. 13 is a functional block diagram illustrating a configuration of an OTA center according to the second embodiment;

FIG. 14 is a diagram illustrating an example in which the functions of the OTA center are implemented by applying the AWS;

FIG. 15A is a flowchart (part 1) illustrating processing from reception of vehicle configuration information to transmission of a job ID and generation of campaign notification information;

FIG. 15B is a flowchart (part 2) illustrating processing from reception of vehicle configuration information to transmission of a job ID and generation of campaign notification information;

FIG. 16 is a flowchart illustrating processing from reception of a campaign information request to generation status check and transmission;

FIG. 17A is a flowchart (part 1) illustrating processing from registration of campaign information to registration of a distribution package to a CDN distribution section;

FIG. 17B is a flowchart (part 2) illustrating processing from registration of campaign information to registration of a distribution package to a CDN distribution section;

FIG. 18 is a flowchart (part 3) illustrating processing from registration of campaign information to registration of a distribution package to a CDN distribution section;

FIG. 19A is a flowchart (part 1) illustrating processing from registration of case information to generation of a package;

FIG. 19B is a flowchart (part 2) illustrating processing from registration of case information to generation of a package;

FIG. 20 is a flowchart (part 3) illustrating processing from registration of case information to generation of a package;

FIG. 21 is a functional block diagram illustrating a configuration of an OTA center according to the third embodiment;

FIG. 22 is a diagram illustrating an example in which the functions of the OTA center are implemented by applying the AWS;

FIG. 23 is a flowchart illustrating processing from reception of vehicle configuration information to transmission of a job ID and generation of campaign notification information;

FIG. 24A is a flowchart (part 1) illustrating processing from reception of a campaign information request to check of a generation status and transmission of the campaign notification information;

FIG. 24B is a flowchart (part 2) illustrating processing from reception of the campaign information request to check of a generation status and transmission of the campaign notification information;

FIG. 25A is a flowchart (part 1) illustrating processing from registration of campaign information to registration of a distribution package to a CDN distribution section;

FIG. 25B is a flowchart (part 2) illustrating processing from registration of campaign information to registration of a distribution package to a CDN distribution section;

FIG. 26A is a flowchart (part 1) illustrating processing from reception of a registration request of case information to check and transmission of registration information;

FIG. 26B is a flowchart (part 2) illustrating processing from reception of a registration request of case information to check and transmission of registration information;

FIG. 27 is a diagram for describing a problem that may occur in the third embodiment in the fourth embodiment;

FIG. 28 is a functional block diagram illustrating a configuration of an OTA center;

FIG. 29 is a diagram illustrating an example in which the functions of the OTA center are implemented by applying the AWS;

FIG. 30 is a flowchart illustrating processing from reception of vehicle configuration information to transmission of a job ID and generation of campaign notification information;

FIG. 31 is a functional block diagram illustrating a configuration of an OTA center according to the fifth embodiment;

FIG. 32 is a diagram illustrating an example in which the functions of the OTA center are implemented by applying the AWS;

FIG. 33 is a flowchart illustrating processing from reception of vehicle configuration information to transmission of a job ID and generation of campaign notification information;

FIG. 34 is a flowchart illustrating processing from registration of campaign information to registration of a distribution package to a CDN distribution section;

FIG. 35 is a flowchart illustrating processing from registration of case information to generation of a package;

FIG. 36 is a functional block diagram illustrating a configuration of an OTA center according to the sixth embodiment;

FIG. 37 is a diagram illustrating an example in which the functions of the OTA center are implemented by applying the AWS;

FIG. 38A is a flowchart (part 1) illustrating processing from reception of a campaign information request to check of a generation status and transmission of the campaign notification information;

FIG. 38B is a flowchart (part 2) illustrating processing from reception of a campaign information request to check of a generation status and transmission of the campaign notification information;

FIG. 39 is a flowchart illustrating processing from data access by the vehicle to distribution of a package by the CDN distribution section;

FIG. 40 is a functional block diagram assuming a case where the functions of the OTA center are mainly configured by applying a server architecture;

FIG. 41 is a diagram illustrating a tendency of server access by a time zone in the connected car service;

FIG. 42 is a diagram illustrating a difference in the number of vehicles sold in each region;

FIG. 43 is a functional block diagram illustrating a configuration of an OTA center according to the seventh embodiment; and

FIG. 44 is an example of a case where a center device 1E illustrated in FIG. 43 is configured using the AWS cloud.

### DETAILED DESCRIPTION

In recent years, with diversification of vehicle control such as a driving assistance function and an automated driving function, a scale of application programs for vehicle control, diagnosis, and the like mounted on an electronic control device (hereinafter, referred to as an electronic control section (ECU)) of a vehicle is increasing. In addition, with the version up by function improvement or the like, there is an increasing opportunity to perform so-called reprogramming in which the application program of the ECU is rewritten. On the other hand, with the development of communication networks and the like, connected car technology has also become widespread.

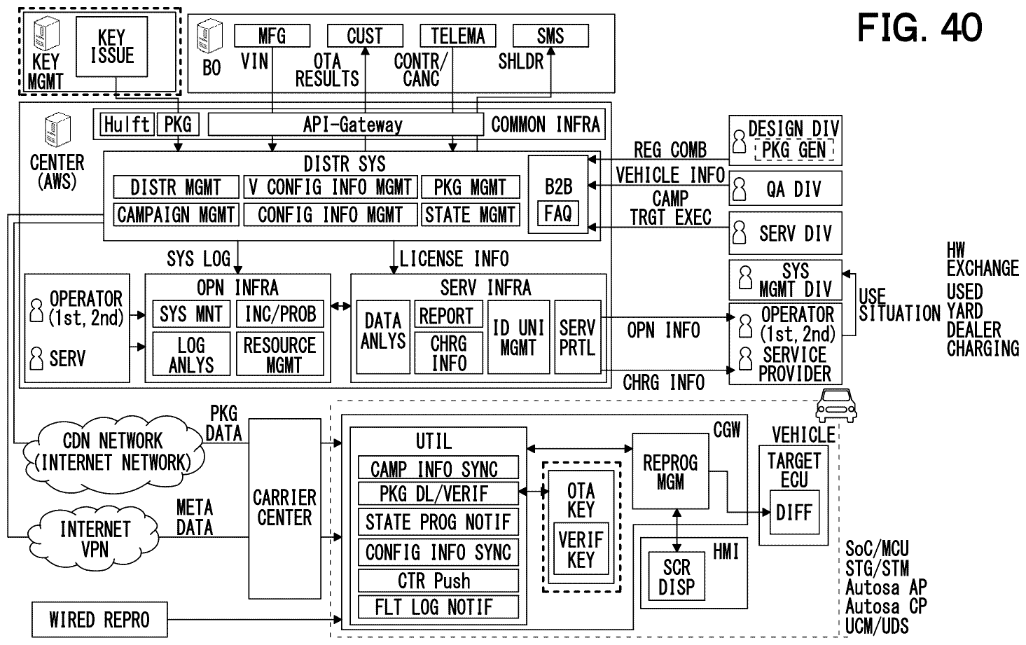

When the center device disclosed in a related art is actually configured, for example, a configuration as illustrated in FIG. 40 is obtained, and it is assumed that each of the management blocks and the like constituting the center device is realized by an architecture on the assumption that a server is generally used. In the present application, an environment or a configuration for executing the application program on the premise of using a server is referred to as a “server architecture”. In other words, in the server architecture, a resource is constantly allocated to the application program, and the program is executed as a resident type process.

The abbreviation in FIG. 40 will be explained as follows. “KEY MGMT” corresponds to key management center. “KEY ISSUE” corresponds to OTA key issuance/management. “BO” corresponds to OEM back office. “MFG” corresponds to manufacturing information system management system. “CUST” corresponds to customer management system. “OTA RESULTS” corresponds to OTA results/implementation history. “TELEMA” corresponds to telematics contract system. “CONTR/CANC” corresponds to telematics contract/cancellation. “SMS” corresponds to SMS distribution center. “SHLDR” corresponds to shoulder tap. “COMMON INFRA” corresponds to common infrastructure. “CENTER” corresponds to OTA center. “DISTR SYS” corresponds to OTA distribution system. “DISTR MGMT” corresponds to distribution management. “V CONFIG INFO MGMT” corresponds to vehicle configuration information management. “PKG MGMT” corresponds to package management. “CAMPAIGN MGMT” corresponds to campaign management. “CONFIG INFO MGMT” corresponds to configuration information management. “STATE MGMT” corresponds to state management/output of individual vehicle. “B2B” corresponds to B2B portal. “OPERATOR” corresponds to OTA operator. “SERV” corresponds to OTA service provider. “SYS LOG” corresponds to system log/analysis log/error information. “OPN INFRA” corresponds to operational infrastructure. “SYS MNT” corresponds to system monitoring. “INC/PROB” corresponds to incident/problem management. “LOG ANLYS” corresponds to LOG analysis. “RESOURCE MGMT” corresponds to asset management/resource management. “LICENSE INFO” corresponds to license information/charging source data, OTA record/ID information. “SERV INFRA” corresponds to service infrastructure. “DATA ANLYS” corresponds to data analysis. “REPORT” corresponds to report output. “CHRG INFO” corresponds to charging information output. “ID UNI MGMT” corresponds to ID unified management. “SERV PRTL” corresponds to service portal. “REG COMB” corresponds to regular combination campaign information package file. “DESIGN DIV” corresponds to vehicle design division. “PKG GEN” corresponds to package generation. “VEHICLE INFO” corresponds to target vehicle information. “QA DIV” corresponds to quality assurance division. “CAMP TRGT EXEC” corresponds to campaign target vehicle execution date. “SERV DIV” corresponds to service division. “SYS MGMT DIV” corresponds to OTA system management division. “OPN INFO” corresponds to operation/maintenance information. “CHRG INFO” corresponds to charging/billing information. “USE SITUATION” corresponds to use situation/charging information. “USED” corresponds to sales of used vehicle. “PKG DATA” corresponds to package data. “WIRED REPRO” corresponds to wired reprogramming tool. “UTIL” corresponds to utility/downloader. “CAMP INFO SYNC” corresponds to campaign information synchronization. “PKG DL/VERIF” corresponds to package download/verification. “STATE PROG NOTIF” corresponds to OTA state progress notification. “CONFIG INFO SYNC” corresponds to vehicle configuration information synchronization. “CTR Push” corresponds to center Push. “FLT LOG NOTIF” corresponds to fault log information notification. “VERIF KEY” corresponds to verification key placement. “REPROG MGM” corresponds to reprogramming management (installation). “SCR DISP” corresponds to screen display. “HMI” corresponds to in-vehicle HMI. “DIFF” corresponds to difference update. “STG/STM” corresponds to storage/streaming.

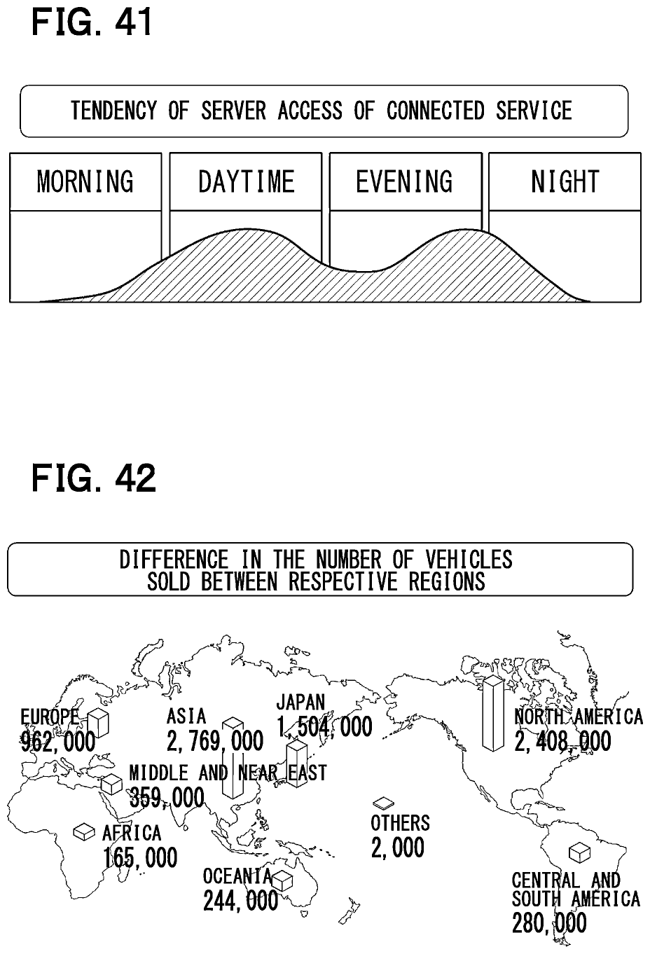

As illustrated in FIG. 41, it is assumed that the access from the vehicle to the server included in the center device increases during the day and decreases during the night. Therefore, when the server is operated at night, the cost is wasteful.

In addition, legally, it is necessary to install a center device corresponding to a connected car in each country. Therefore, when a system of the same scale is constructed for each country, in an area where there are few vehicles, the cost of operating the server is wasteful (see FIG. 42).

The present disclosure provides a center device that performs wireless communication with a plurality of vehicles at a lower cost.

According to one aspect of the present disclosure, a center device that manages data to be written in an electronic control device mounted on a vehicle and performs, by an application program, a plurality of functions for transmitting update data to the vehicle by wireless communication is provided. An application program implementing at least one of the functions adopts a server architecture in which a resource is always allocated and that executes as a resident-type process. An application program implementing at least one of the other functions adopts a serverless architecture in which the application program is activated upon occurrence of an event and is dynamically allocated with a resource in an on-demand manner for execution of a code of the application program, and in which the resource allocated to the application program is released when the execution of the code is terminated. The center device includes: a campaign determination section that is configured to receive vehicle configuration information from the vehicle and determine whether there is campaign information for the vehicle; a campaign generation section that is configured to generate campaign notification information for the vehicle when there is the campaign information; a status management section that is configured to manage a generation state of the campaign notification information; and a campaign transmission section that is configured to distribute the campaign notification information to the vehicle according to the generation state. The application program that implements functions of the campaign determination section, the status management section, and the campaign generation section adopts the serverless architecture.

According to another aspect of the present disclosure, a center device that manages data to be written in an electronic control device mounted on a vehicle and performs, by an application program, a plurality of functions to transmit update data to the vehicle by wireless communication is provided. An application program implementing at least one of the functions adopts a serverless architecture in which the application program is activated upon occurrence of an event and is dynamically allocated with a resource in an on-demand manner for execution of a code of the application program, and in which the resource allocated to the application program is released when the execution of the code is terminated. The center device includes: a campaign determination section that is configured to receive vehicle configuration information from the vehicle and determine whether there is campaign information for the vehicle; a campaign generation section that is configured to generate campaign notification information for the vehicle when there is the campaign information; a status management section that is configured to manage a generation state of the campaign notification information; and a campaign transmission section that is configured to distribute the campaign notification information to a vehicle according to the generation state. An application program that implements functions of the campaign determination section, the status management section, and the campaign generation section adopts the serverless architecture.

According to another aspect of the present disclosure, a method of distributing campaign information is provided. The method includes managing data to be written to an electronic control device mounted on a vehicle. An application program executes a plurality of functions for transmitting update data to the vehicle by wireless communication. An application program that implements some functions adopts a server architecture in which a resource is constantly allocated and that is executed as a resident type process. An application program that implements at least some of other functions is activated in response to occurrence of an event, a resource being dynamically allocated for execution of a code of the application program by an on-demand method, and the application program adopts a serverless architecture in which a resource allocated to the application program is released when execution of the code is completed. The method includes: receiving vehicle configuration information from a vehicle and determining whether there is campaign information for the vehicle; generating campaign notification information for the vehicle when there is the campaign information; and managing a generation state of the campaign notification information and distributing the campaign notification information to a vehicle according to the generation state. An application program that implements functions of determination as to whether there is the campaign information, management of a generation state of the campaign notification information, and generation of the campaign notification information adopts the serverless architecture.

According to another aspect of the present disclosure, a method of distributing campaign information is provided. The method includes managing data to be written to an electronic control device mounted on a vehicle. An application program executes a plurality of functions for transmitting update data to the vehicle by wireless communication. An application program that implements at least some functions is activated in response to occurrence of an event. A resource is dynamically allocated for execution of a code of the application program by an on-demand method. The application program adopts a serverless architecture in which a resource allocated to the application program is released when execution of the code is completed. The method includes: receiving vehicle configuration information from a vehicle and determining whether there is campaign information for the vehicle; generating campaign notification information for the vehicle when there is the campaign information; and managing a generation state of the campaign notification information and distributing the campaign notification information to a vehicle according to the generation state. An application program that implements functions of determination as to whether there is the campaign information, management of a generation state of the campaign notification information, and generation of the campaign notification information adopts the serverless architecture.

As described above, the number of accesses from the vehicle to the center device varies depending on the time zone, and the number of vehicles varies depending on the region. When the application program that implements at least some functions adopts the serverless architecture, the resource is dynamically allocated and the program is activated every time access from the vehicle occurs, and the resource is released when the execution of the code is completed. Therefore, as compared with a case of adopting a server architecture executed as a resident type process, consumption of computing resources can be saved, and as a result, running costs for the infrastructure can be reduced.

In addition, the campaign determination section receives vehicle configuration information from the vehicle and determines whether there is campaign information for the vehicle. When there is campaign information, the campaign generation section generates campaign notification information for the vehicle. The status management section manages a generation state of the campaign notification information, and the campaign transmission section distributes the campaign notification information to the vehicle according to the generation state. An application program that implements the functions of the campaign determination section, the status management section, and the campaign generation section adopts a serverless architecture.

For example, since the status management section manages the generation state of the campaign notification information even in communication in which connection management is required to be performed, the campaign generation section and the campaign transmission section do not need to continue to operate during a period until the campaign notification information is distributed to the vehicle. Therefore, it is possible to enjoy more merits of realizing these functions by the serverless architecture.

### First Embodiment

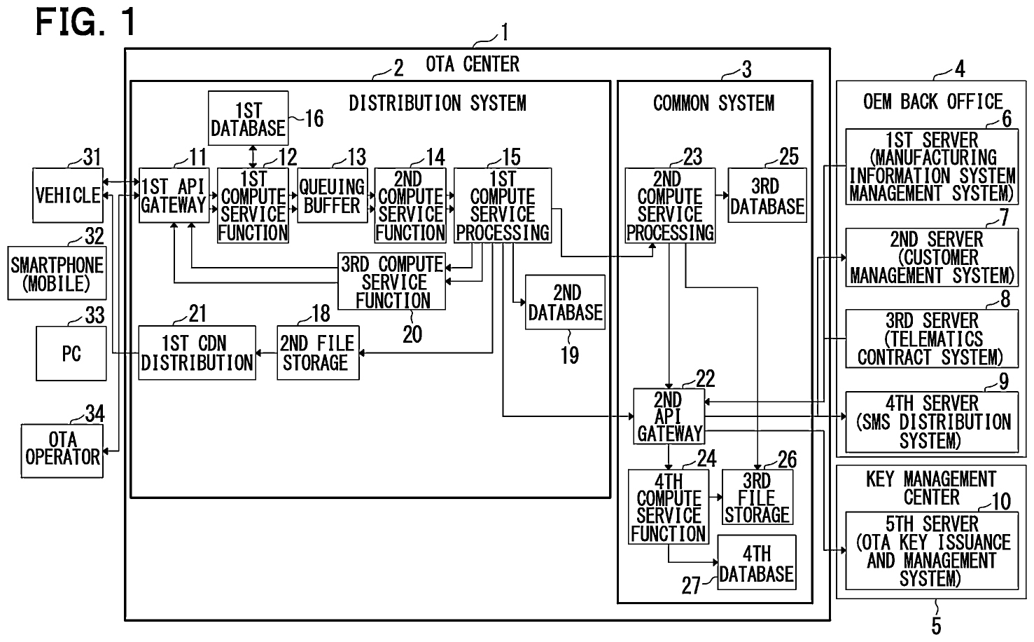

Hereinafter, a first embodiment will be described. As illustrated in FIG. 1, an OTA center 1 which is a center device of the present embodiment includes a distribution system 2 and a common system 3. In the common system 3, a distribution package including an update program and data of the ECU to be distributed to a vehicle 31 which is a vehicle is generated and managed, and the generated distribution package is distributed to the vehicle 31 via the distribution system 2 by wireless communication, that is, by an OTA.

When the common system 3 generates a package, necessary data is transmitted and received to and from an original equipment manufacturer (OEM) back office 4 which is an external server system and a key management center 5. The OEM back office 4 includes a first server 6 to a fourth server 9, and the like. These servers 6 to 9 are similar to those illustrated in FIG. 40, and are systems for manufacturing information management system, customer management system, telematics contract, and short message service (SMS) distribution, respectively. The key management center 5 includes a fifth server 10 that is a system that issues and manages a key used for the OTA.

In the first server 6 to the fifth server 10, the above-described server architecture is used, a resource is constantly allocated to the application program, and the program is executed as a resident type process.

An application programming interface (API) gateway section (1) 11 of the distribution system 2 performs wireless communication with the vehicle 31 and an OTA operator 34. The data received by the API gateway section 11 is sequentially transferred to a compute service function section (1) 12, a queuing buffer section 13, a compute service function section (2) 14, and a compute service processing section (1) 15. The compute service function section 12 accesses a database section (1) 16. The compute service processing section 15 accesses a file storage section 18 and a database section (2) 19. The database section 19 stores campaign information that is update information of software corresponding to the vehicle 31 that requires program update. The API gateway section 11 exchanges data input/output, instructions, and responses with the vehicle 31, the OTA operator 34, a smartphone 32, a PC33, and the like.

The data output from the compute service processing section 15 is output to the API gateway section 11 via the compute service function section (3) 20. A contents distribution network (CDN) distribution section 21 accesses the file storage section 18 and distributes data stored in the file storage section 18 to the vehicle 31 by the OTA. The CDN distribution section 21 is an example of a network distribution section.

The API gateway section (2) 22 of the common system 3 inputs and outputs data to and from the compute service processing section 15 of the distribution system 2, and the compute service processing section (2) 23 and the compute service function section (4) 24 included in the common system 3. The compute service processing section 23 accesses a database section (3) 25 and a file storage section (3) 26. The compute service function section 24 accesses a file storage section 26 and a database section (4) 27. The API gateway section 22 also accesses the respective servers 6 to 10 included in the OEM back office 4 and the key management center 5. The API gateway section 22 exchanges data input/output, instructions, and responses with the respective servers 6 to 10 included in the OEM back office 4 and the key management center 5.

In the drawings, transmission and reception of commands and data are indicated by lines for convenience of description. However, even when it is not indicated by a line, it is possible to call the processing section, the function section, or the management section or to access the database section or the storage section.

In the above configuration, the compute service function sections 12, 14, 20, and 24 and the compute service processing sections 15 and 23 adopt a serverless architecture. The “serverless architecture” is activated in response to occurrence of an event, and a resource is automatically allocated for execution of a code of an application program by an on-demand method. The allocated resource is configured to be automatically released when the execution of the code is completed, and is based on a design concept opposite to the above-described “server architecture”.

In addition, the “serverless architecture” is activated in response to the occurrence of an event, resource is dynamically allocated to the execution of the code of the application program, and the allocated resource is released when the execution of the code is completed. When the execution of the code is completed, the resource is dynamically released. The resource may be released immediately after completion of the execution of the code, or may be released after waiting for a predetermined time, for example, 10 seconds, after completion of the execution. Four principles for configuring a serverless architecture are:
Use a computing service, without using a server, to execute a program code on demand;
A straight function having only one purpose;
Configure a push-based event-driven pipeline; and
Configure a thicker and stronger front end, and so on.

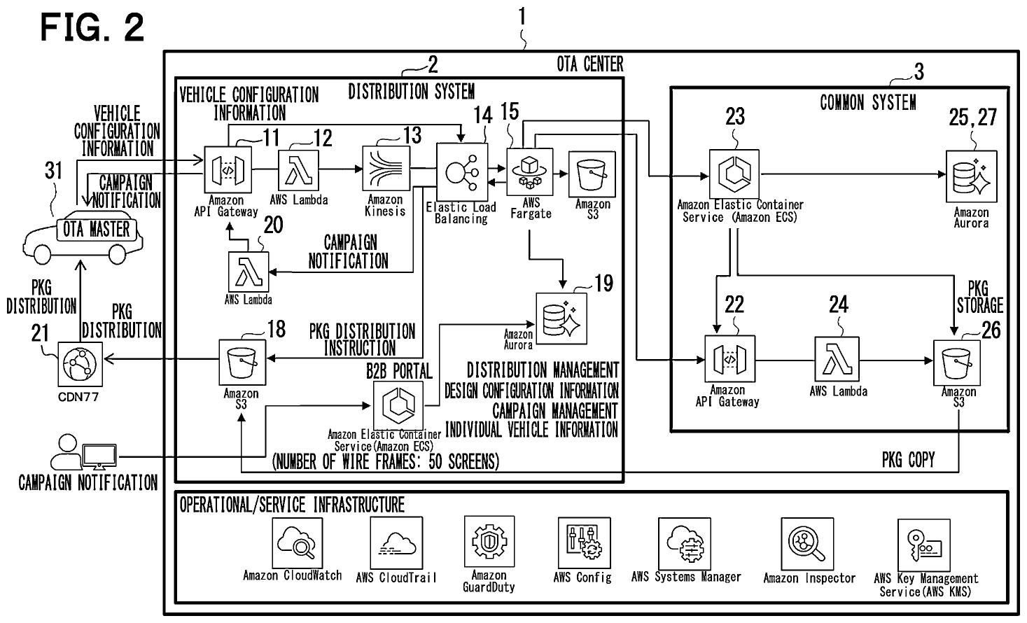

FIG. 2 is an example of a case where a center device 1 illustrated in FIG. 1 is configured using an Amazon web service (AWS) cloud.

Amazon API Gateway corresponds to the API gateway sections 11 and 22.

AWS Lambda corresponds to the compute service function sections 12, 20, and 24.

Amazon Kinesis corresponds to the queuing buffer section 13.

Elastic Load Balancing corresponds to the compute service function section 14.

AWS Fargate corresponds to the compute service processing section 15.

Amazon S3 corresponds to the file storage sections 18 and 26.

Amazon Aurora corresponds to the database sections 19, 25, and 27.

Since Lamdba and Fargate can realize functions equivalent to each other, in the embodiment and the drawing, a portion described as Lamdba can be configured by Fargate, and a portion described as Fargate can be configured by Lamdba.

The CDN 77 corresponds to the CDN distribution section 21, which is a service provided by the CDN 77. This may be replaced with the Amazon CloudFront service provided by the AWS. The CDN 77 is a cache server distributed throughout the world.

The CDN distribution section 21 is not limited to the CDN 77 or the Amazon CloudFront service, and corresponds to an any service or server that realizes a content distribution network. Furthermore, the AWS (Amazon web service) cloud is an example of a cloud service that provides a serverless architecture. The configuration described or illustrated in the embodiment is appropriately changed according to a function provided by a cloud service.

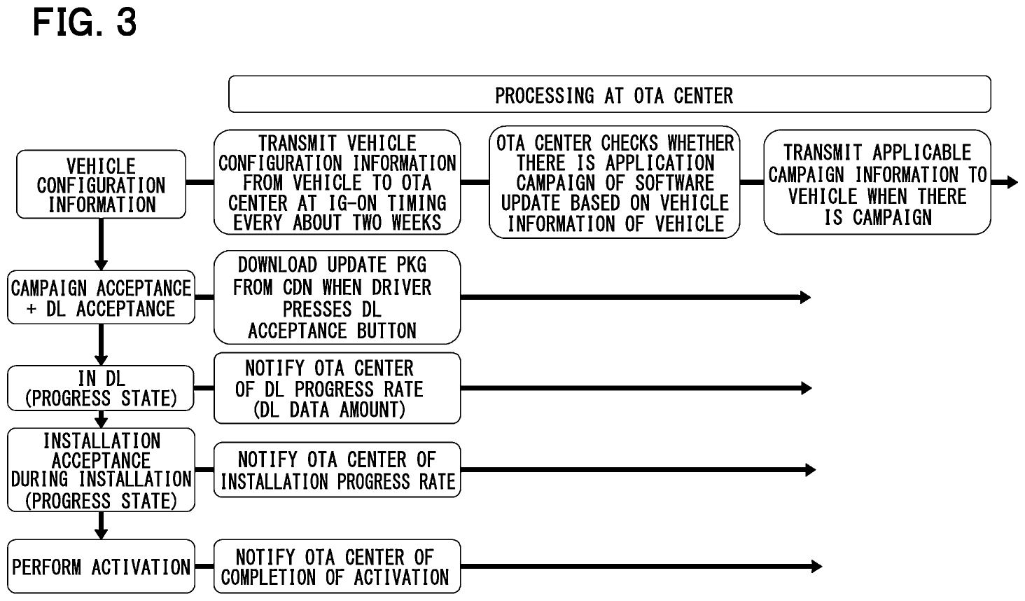

Next, the operation of the present embodiment will be described. As illustrated in FIG. 3, in the phase of “vehicle configuration information synchronization”, the vehicle configuration information is transmitted to the OTA center 1 at the timing when the ignition switch is turned ON in the vehicle 31, for example, every two weeks. When the campaign occurs, a short message may be transmitted from the fourth server 9 to the vehicle to be campaigned, and the vehicle configuration information may be transmitted to the OTA center 1 using the short message as a trigger. The vehicle configuration information is information related to hardware and software of an ECU mounted on the vehicle. Based on the transmitted vehicle configuration information, the OTA center 1 checks whether there is campaign information to be applied for software update. When there is corresponding campaign information, the campaign information is transmitted to the vehicle 31. When the vehicle configuration information is transmitted by the vehicle 31, the process of comparing the information with the vehicle configuration information of the vehicle 31 held on the OTA center 1 side and updating the information to the newer information is referred to as a synchronization process of the vehicle configuration information.

In the phase of “campaign acceptance+DL acceptance”, when the driver of the vehicle 31 receiving the campaign information presses a button for accepting the download, the button displayed on the screen of the in-vehicle device, the data package for program update is downloaded from the CDN distribution section 21. During the download, the vehicle 31 notifies the OTA center 1 of the progress rate of the download processing.

When the download is completed and the installation performed with “installation acceptance”, the vehicle 31 notifies the OTA center 1 of the progress rate of the installation process. When the installation process is completed, the status of the vehicle 31 is “execution of activation”, and the activation is completed, the OTA center 1 is notified of the completion of the activation.

Hereinafter, details of each process described above will be described.

### <Reception of Vehicle Configuration Information→Transmission of Campaign Information>

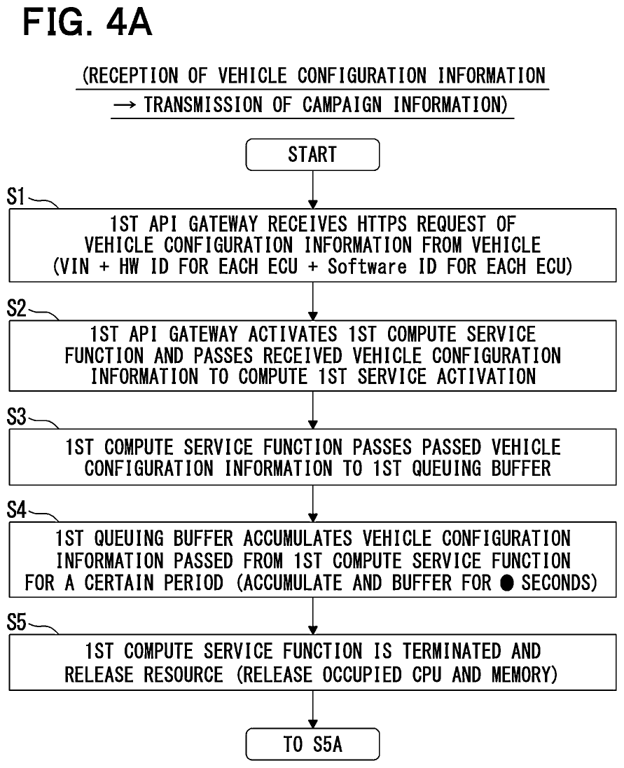

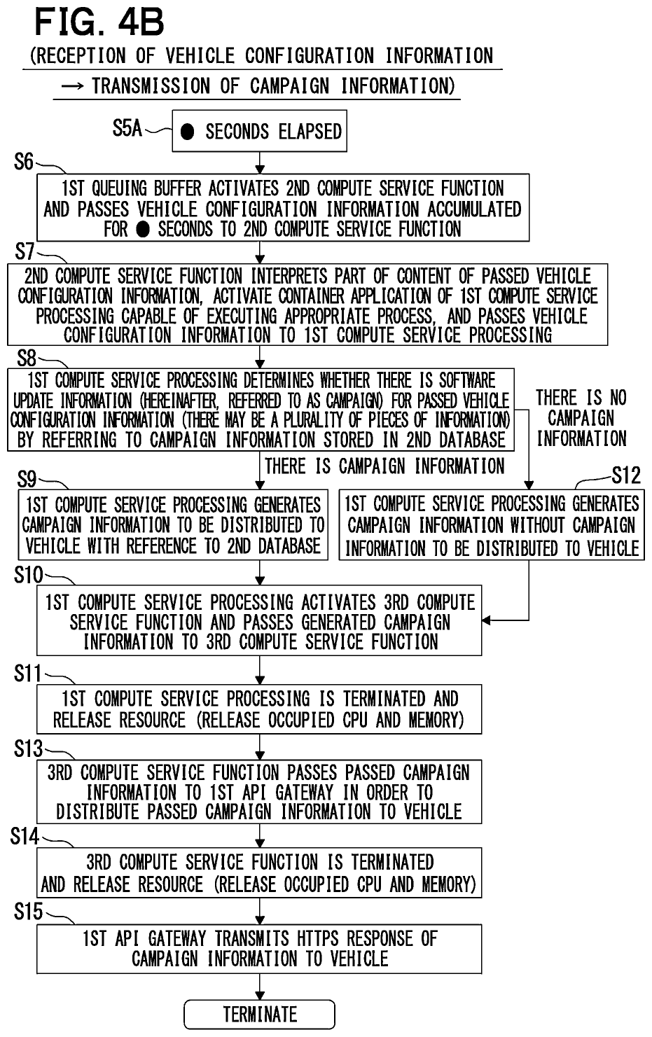

As illustrated in FIG. 4A and FIG. 4B, the API gateway section 11 receives a Hypertext Transfer Protocol Secure (HTTPS) request of the vehicle configuration information from the vehicle 31 (S1). The request content is, for example, a vehicle identification number (VIN), a hardware ID of each ECU, a software ID of each ECU, and the like. Next, when activating the compute service function section 12, the API gateway section 11 passes the received vehicle configuration information to the function section 12 (S2).

The compute service function section 12 passes the vehicle configuration information to the queuing buffer section 13 (S3). The queuing buffer section 13 accumulates and buffers the passed vehicle configuration information for a certain period, for example, one second or several seconds (S4). The compute service function section 12 terminates the process and releases the resources such as the CPU and the memory occupied for performing the process (S5). The compute service function section 12 may receive the TCP port number from the API gateway section 11 and store the TCP port number in the shared memory as necessary.

The container application of the compute service processing section 15 includes a container application related to generation of campaign notification information, a container application related to registration of a distribution package, a container application related to generation of a package, and the like. The compute service function section 14 interprets the passed information and activates a corresponding container application.

When the certain period has elapsed (S5A), the queuing buffer section 13 activates the compute service function section 14 and passes the vehicle configuration information accumulated within the certain period to the compute service function section 14 (S6). The queuing buffer section 13 is an example of an access buffer control section. When the compute service function section 14 interprets part of the content of the passed vehicle configuration information and activates the container application of the compute service processing section 15 capable of executing the appropriate process, the compute service function section passes the vehicle configuration information to the compute service processing section 15 (S7).

The container is a collection of libraries, programs, and the like necessary for creating a container as a logical section on the host OS and operating an application. Resources of the OS are logically separated and shared and used by a plurality of containers. An application executed in the container is referred to as a container application.

The compute service processing section 15 accesses the database section 19 and determines whether there is campaign information which is software update information corresponding to the passed vehicle configuration information (S8). When the campaign information exists, the compute service processing section 15 generates the campaign notification information to be distributed to the vehicle 31 with reference to the database section 19 (S9). The compute service processing section 15 is an example of a campaign determination section and a campaign generation section. In addition, the compute service function section 14 corresponds to a first compute service section, and the compute service processing section 15 corresponds to a second compute service section. In step S9, in a case where there is the campaign information and information necessary for distribution to the vehicle 31 is prepared, the process proceeds to step S10.

The compute service processing section 15 activates a compute service function section 20 and passes the generated campaign notification information (S10). The compute service processing section 15 terminates the process and releases the resources such as the CPU and the memory occupied for performing the process (S11). When there is no campaign information in step S8, the campaign notification information for making notification of “there is no campaign” to be distributed to the vehicle 31 is generated (S12), and then the process proceeds to step S10. In step S10, the compute service processing section 15 passes, to the compute service function section 20, the campaign notification information for making notification of “there is a campaign” or the campaign notification information for making notification of “there is no campaign”.

The compute service function section 20 passes the passed campaign notification information to the API gateway section 11 in order to distribute the passed campaign information to the corresponding vehicle 31. The compute service function section 20 terminates the process and releases the resources such as the CPU and the memory occupied for performing the process (S14). The API gateway section 11 transmits an HTTPS response including the campaign notification information to the vehicle 31 (S15). As a result, the vehicle 31 receives the HTTPS response including the campaign notification information. The API gateway section 11 is an example of a campaign transmission section.

In the above processing, the compute service function section 20 may acquire the TCP port number stored by the compute service function section 12 from the shared memory as necessary, and request the API gateway section 11 to distribute the HTTPS response for the TCP port number.

### <Registration of Campaign Information→Registration of Distribution Package to CDN Distribution Section 21>

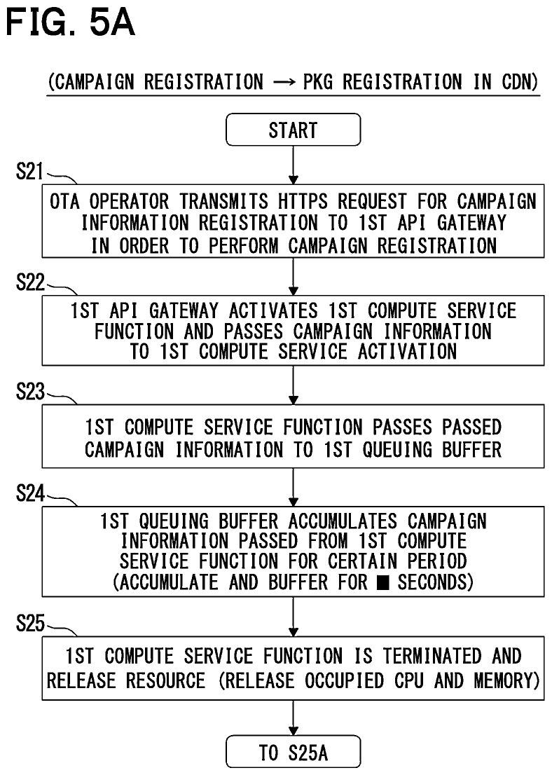

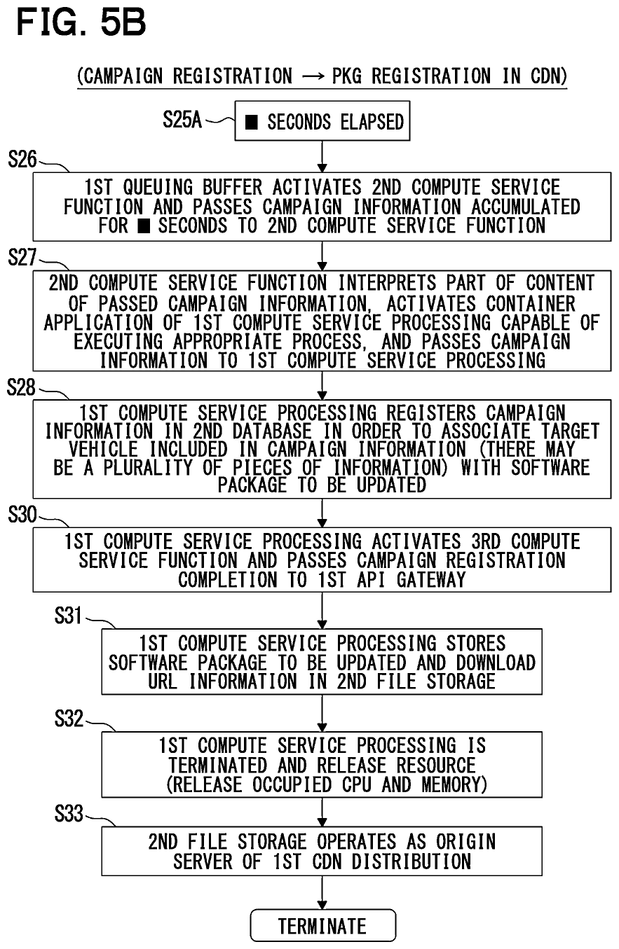

As illustrated in FIG. 5A and FIG. 5B, the OTA operator 34 transmits an HTTPS request for registering campaign information (S21). When activating the compute service function section 12, the API gateway section 11 passes the received campaign information (S22).

The compute service function section 12 passes the campaign information to the queuing buffer section 13 (S23). The queuing buffer section 13 accumulates and buffers the passed campaign information for a certain period (S24). The compute service function section 12 terminates the process and releases the resources such as the CPU and the memory occupied for performing the process (S25). The compute service function section 12 is an example of a campaign registration section and corresponds to a fifth compute service section.

When the certain period has elapsed (S25A), the queuing buffer section 13 activates the compute service function section 14 and passes the campaign information accumulated within the certain period to the compute service function section 14 (S26). When the compute service function section 14 interprets part of the content of the passed campaign information and activates the container application of the compute service processing section 15 capable of executing the appropriate process, the compute service function section passes the campaign information to the compute service processing section 15 (S27).

The compute service processing section 15 registers the campaign information in the database section 19 in order to associate the target vehicle included in the passed campaign information with the software package to be updated (S28). In addition, the compute service processing section 15 activates the compute service function section 20 and passes a notification indicating that the registration of the campaign information is completed to the API gateway section 11 (S30). In step S30, the API gateway section 11 transmits the HTTPS response including the completion of the campaign information registration to the OTA operator 34. The compute service processing section 15 is an example of a campaign registration section and corresponds to a fourth compute service section.

Next, the compute service processing section 15 stores the software package to be updated and the URL information for download in the file storage section 18 (S31). The compute service processing section 15 terminates the process and releases the resources such as the CPU and the memory occupied for performing the process (S32). The file storage section 18 operates as an origin server of the CDN distribution section 21 (S33). The compute service processing section 15 is an example of a package distribution section and corresponds to a third compute service section. The origin server is a server in which original data exists. The file storage section 18 stores all the software package to be updated and the URL information for download.

### <Data Access From Vehicle→Transmit Distribution Package From CDN to Vehicle>

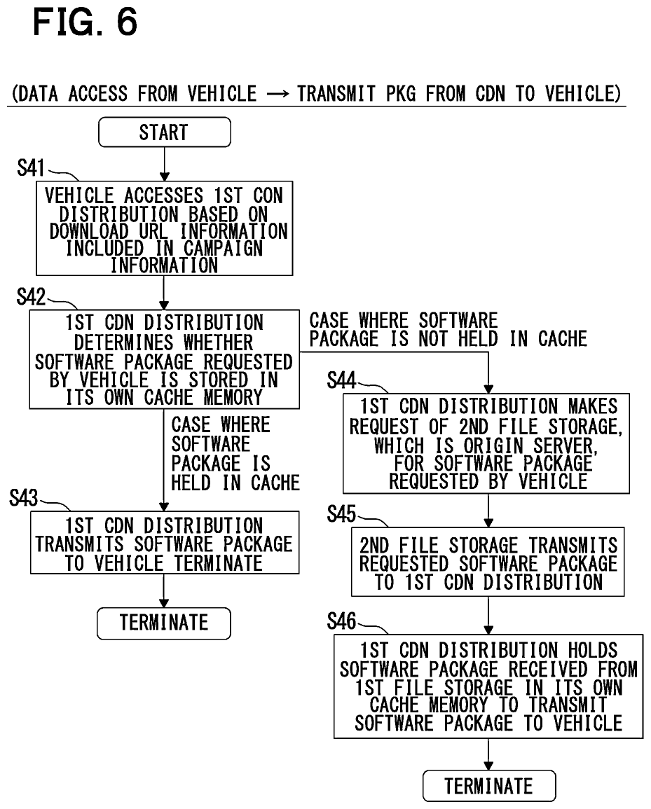

As illustrated in FIG. 6, in the vehicle 31, an OTA master including a data communication module (DCM) and a central ECU actually mounted on the vehicle 31 accesses the CDN distribution section 21 based on the download URL information included in the campaign notification information (S41). The CDN distribution section 21 determines whether the software package requested from the vehicle 31 is held in its own cache memory (S42). When the software package is held in the cache memory, the CDN distribution section 21 transmits the software package to the vehicle 31 (S43).

On the other hand, when the requested software package is not held in the cache memory, the CDN distribution section 21 makes a request of the file storage section 18 which is the origin server for the software package (S44). Then, the file storage section 18 transmits the requested software package to the CDN distribution section 21 (S45). The CDN distribution section 21 holds the software package received from the file storage section 18 in its own cache memory and transmits the software package to the vehicle 31 (S46).

### <Registration of Software Update Data>

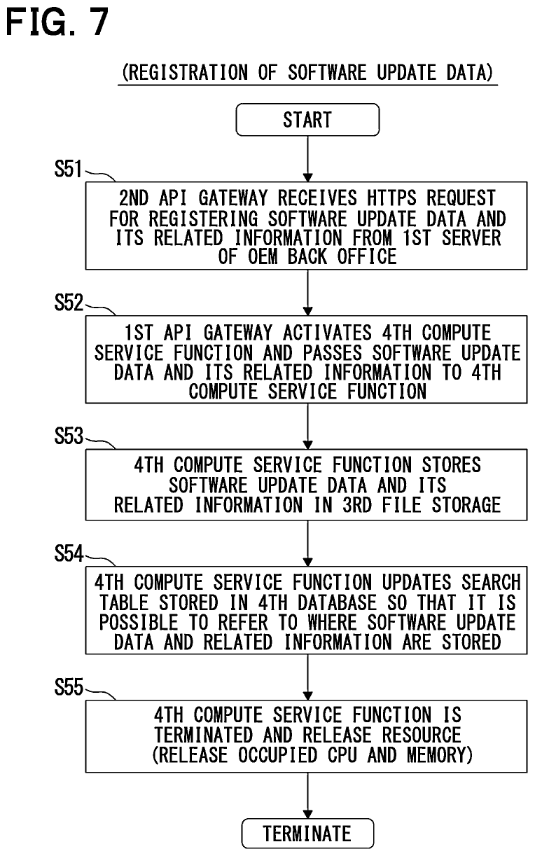

As illustrated in FIG. 7, the API gateway section 22 receives a request for registration of the software update data and its related information as an HTTPS request from the first server 6 of the OEM back office 4 (S51). The API gateway section 22 activates the compute service function section 24 and passes the software update data and the related information (S52). The compute service function section 24 stores the software update data and the related information in the file storage section 26 (S53).

The compute service function section 24 updates the search table stored in the database section 27 so that it is possible to refer to where the software update data and the related information are stored (S54). The compute service function section 24 terminates the process and releases the resources such as the CPU and the memory occupied for performing the process (S55).

In step S55, the compute service function section 24 may be caused to notify the API gateway section 22 that the process has been completed, and the API gateway section 22 may transmit, to the OEM back office 4, an HTTPS response including that the registration of the software update data and its related information has been completed.

### <Registration of Case Information→Generation of Package>

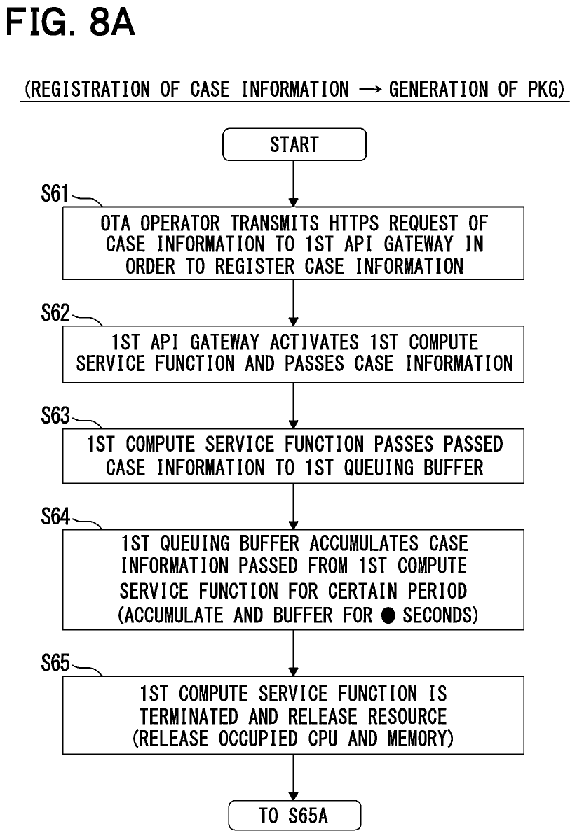

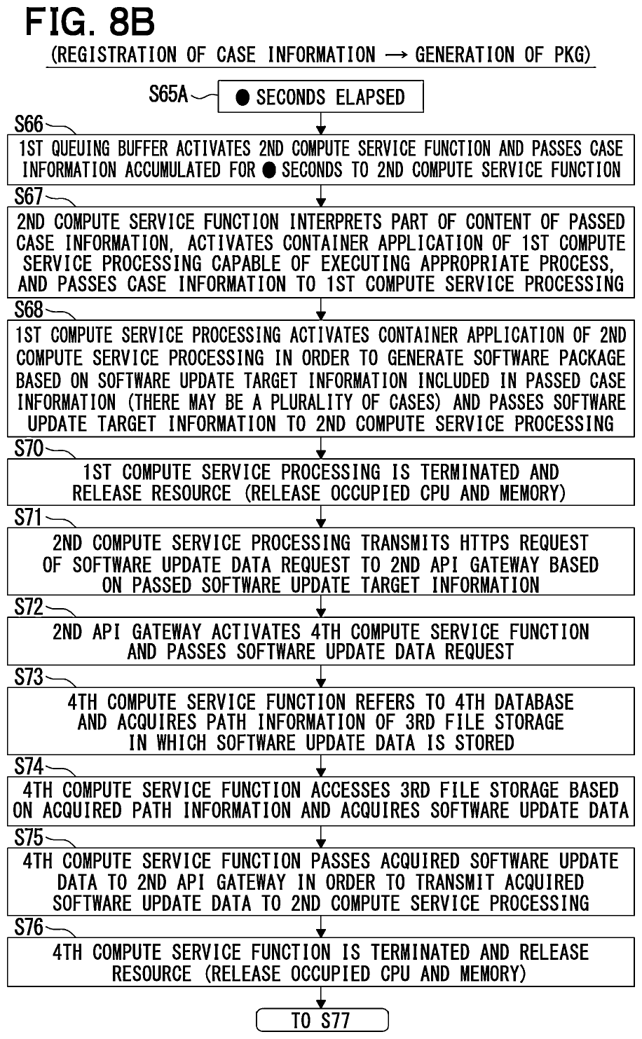

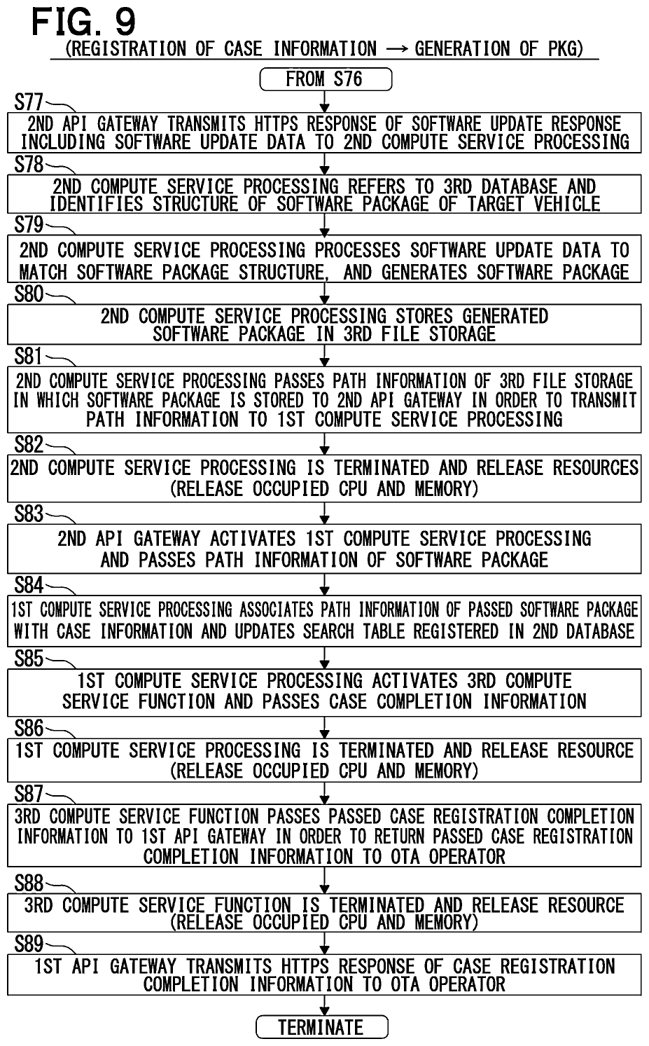

As illustrated in FIG. 8A and FIG. 8B, in order to register the case information, the OTA operator 34 transmits an HTTPS request of the case information to the API gateway section 11 (S61). The case information is a collection of hardware information and software information of the ECU to which a certain distribution package is applicable. When activating the compute service function section 12, the API gateway section 11 passes the received case information to the function section 12 (S62).

The compute service function section 12 passes the case information to the queuing buffer section 13 (S63). The queuing buffer section 13 accumulates and buffers the passed case information for a certain period (S64). The compute service function section 12 terminates the process and releases the resources such as the CPU and the memory occupied for performing the process (S65). The compute service function section 12 may receive the TCP port number from the API gateway section 11 and store the TCP port number in the shared memory as necessary.

When the certain period has elapsed, the queuing buffer section 13 activates the compute service function section 14 and passes the case information accumulated within the certain period to the compute service function section 14 (S66). When the compute service function section 14 interprets part of the content of the passed case information and activates the container application of the compute service processing section 15 capable of executing the appropriate process, the compute service function section passes the case information to the compute service processing section 15 (S67).

The compute service processing section 15 accesses the database section 19, activates a container application of the compute service processing section 23 in order to generate a software package based on the software update target information included in the passed case information, and passes the software update target information to the compute service processing section 23 (S68). The compute service processing section 15 terminates the process and releases the resources such as the CPU and the memory occupied for performing the process (S70).

The compute service processing section 23 transmits an HTTPS request of a software update data request to the API gateway section 22 based on the passed software update target information (S71). The API gateway section 22 activates the compute service function section 24 and passes a software update data request (S72). The compute service function section 24 refers to a database section 27 and acquires the path information of the file storage section 26 in which the software update data is stored (S73).

The compute service function section 24 accesses the file storage section 26 based on the acquired path information and acquires software update data (S74). In order to transmit the acquired software update data to the compute service processing section 23, the acquired software update data is passed to the API gateway section 22 (S75). The compute service function section 24 terminates the process and releases the resources such as the CPU and the memory occupied for performing the process (S76). The compute service function section 24 is an example of a data management section.

The API gateway section 22 transmits an HTTPS response of a software update response including the software update data to the compute service processing section 23 (S77). The compute service processing section 23 refers to a database section 25 and identifies the structure of the software package of the target vehicle (S78). The software update data is processed to match the structure of the identified software package to generate a software package (S79). The compute service processing section 23 stores the generated software package in the file storage section 26 (S80). The compute service processing section 23 is an example of a package generation section.

The compute service processing section 23 passes the path information of the file storage section 26 in which the software package is stored to the API gateway section 22 in order to transmit the path information to the compute service processing section 15 (S81). The compute service processing section 23 terminates the process and releases the resources such as the CPU and the memory occupied for performing the process (S82).

The API gateway section 22 activates the compute service processing section 15 and passes the path information of the software package (S83). The compute service processing section 15 associates the passed path information of the software package with the case information, and updates the search table registered in the database section 19 (S84). The compute service processing section 15 activates the compute service function section 20 and passes the case registration completion information (S85). The compute service processing section 15 terminates the process and releases the resources such as the CPU and the memory occupied for performing the process (S86).

The compute service function section 20 passes the passed case registration completion information to the API gateway section 11 in order to return the case registration completion information to the OTA operator 34 (S87). The compute service function section 20 terminates the process and releases the resources such as the CPU and the memory occupied for performing the process (S88). The API gateway section 11 transmits an HTTPS response of the case registration completion information to the OTA operator 34 (S89).

In the above processing, the compute service function section 20 may acquire the TCP port number stored by the compute service function section 12 from the shared memory as necessary, and request the API gateway section 11 to distribute the HTTPS response for the TCP port number.

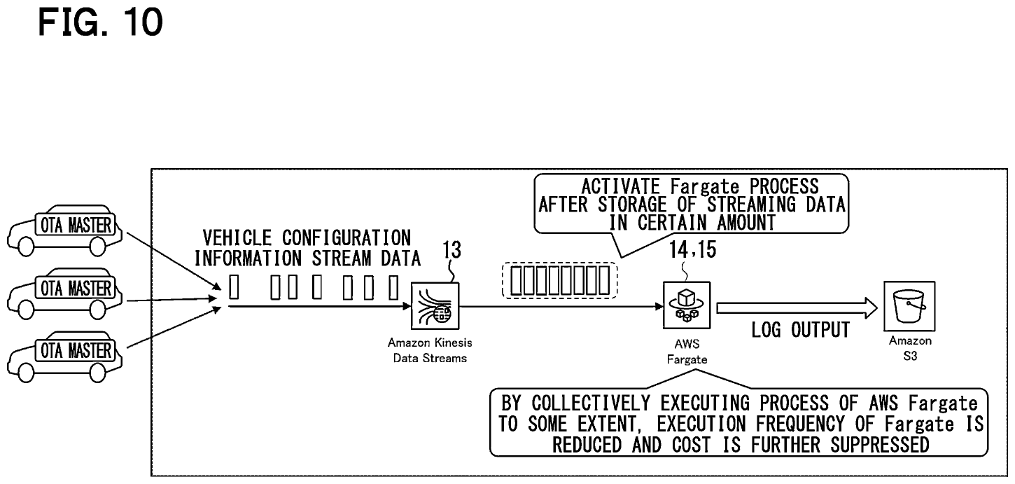

Next, effects of the present embodiment will be described. As illustrated in FIG. 10, the queuing buffer section 13 accumulates a certain amount of stream data of the vehicle configuration information transmitted from each vehicle 31 and then passes the stream data to the next-stage compute service function section 14 and compute service processing section 15. Assuming that the above functions are implemented by AWS Fargate, the consumption of the computing resource can be saved by reducing the execution frequency of the process.

In the queuing buffer section 13, as in the vehicle configuration information, the campaign information and the case information are also accumulated for a certain period and then passed to the next-stage compute service function section 14, thereby reducing the execution frequency of the process and suppressing consumption of the computing resource.

In addition, the queuing buffer section 13 may store the vehicle configuration information, the campaign information, and the case information in one queuing buffer, or may include a plurality of queuing buffer sections 13 and store the information in different queuing buffer sections 13 for each type of information.

Although FIG. 10 illustrates an example in which the vehicle configuration information transmitted from each vehicle 31 is buffered, when the OTA operator 34 performs campaign registration or case information registration, similarly, the queuing buffer section 13 accumulates a certain amount of information and then passes the information to the next-hop compute service function section 14 and compute service processing section 15.

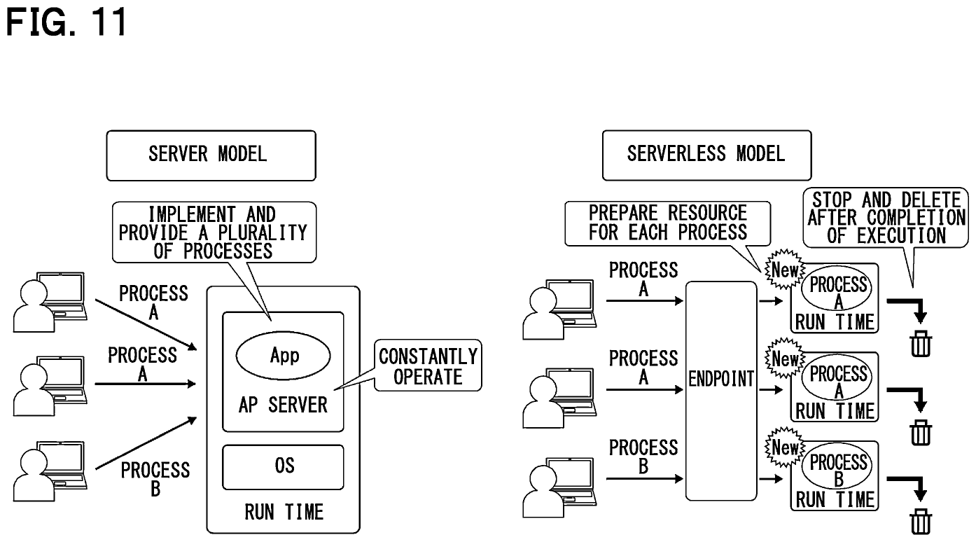

In addition, as illustrated in FIG. 11, in the conventional server model, an application program and a server constantly operate in a state of occupying resources, and one server executes a plurality of processes. On the other hand, in the model adopting the serverless architecture as in the present embodiment, the corresponding application program is started when a request for each process occurs, and the execution of the program is stopped and deleted when the process is terminated. Therefore, at this point, the resource used for the process is released.

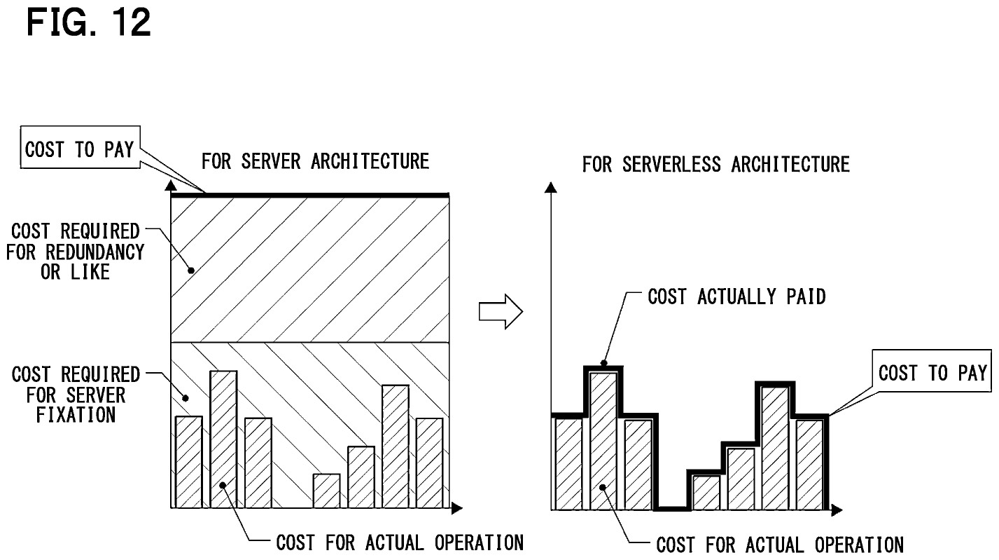

As a result, as illustrated in FIG. 12, in the conventional server model, a fixed cost associated with operating the server constantly is extra compared to an actual operating cost. In addition, when the server is made redundant in advance, the cost is further increased. On the other hand, when the serverless architecture is used as in the present embodiment, only the cost of substantially actual operation is borne, so that the running cost required for the infrastructure can be greatly reduced.

As described above, according to the present embodiment, the OTA center 1 manages data to be written to a plurality of ECUs mounted on the vehicle 31, and executes, by the application program, a plurality of functions for transmitting update data to the vehicle 31 by wireless communication. At this time, a serverless architecture is used in which an application program that implements at least some functions is started in response to occurrence of an event, a resource is dynamically allocated for execution of a code of the application program by an on-demand method, and the resource allocated to the application program is released when the execution of the code is completed.

In the program adopting the serverless architecture, the resource is dynamically allocated and the program is started every time access from the vehicle 31 occurs, and the resource is released when the execution of the code is completed. Therefore, as compared with a case of adopting a server architecture executed as a resident type process, consumption of computing resources of the infrastructure can be saved, and as a result, running costs for the infrastructure can be reduced.

### Second Embodiment

Hereinafter, the parts equal to those in the first embodiment will be denoted by the equal reference numerals, description thereof will be omitted, and different parts will be described. Assuming that communication between the vehicle 31 and the OTA center 1 is performed by a transmission control protocol (TCP), which is connection-type communication, it is necessary to perform connection management between transmission and reception. Similarly, assuming that communication between the OTA operator 34 and the OTA center 1 is performed by a transmission control protocol (TCP), which is connection-type communication, it is necessary to perform connection management between transmission and reception.

First, when a connection is established, a handshake process such as:
a TCP packet in which a SYN (connection establishment request) flag is enabled is transmitted as an establishment request from the transmission side;
the reception side transmits an Acknowledge (ACK) in response to this, and the SYN flag of the TCP header as a connection establishment request from the reception side simultaneously after the SYN flag is enabled; and
the transmission side transmits an ACK packet for the SYN from the reception side, is required.

When disconnecting the connection, a handshake process such as:
the transmitting side first transmits a FIN (connection termination request);
the receiver transmits an ACK and subsequently transmits the FIN; and
after receiving the FIN and transmitting the last ACK, the transmission side waits for a certain period of time and terminates the connection, is required.

In the configuration of the first embodiment, in consideration of performing the connection management described above, it is necessary to constantly link the compute service function sections 12 and 20 illustrated in FIG. 1. In addition, since the compute service function sections 12 and 20 need to operate the processes until the processes at the subsequent stages are completed and a response is returned, it is not possible to receive the maximum benefit of adopting the serverless architecture.

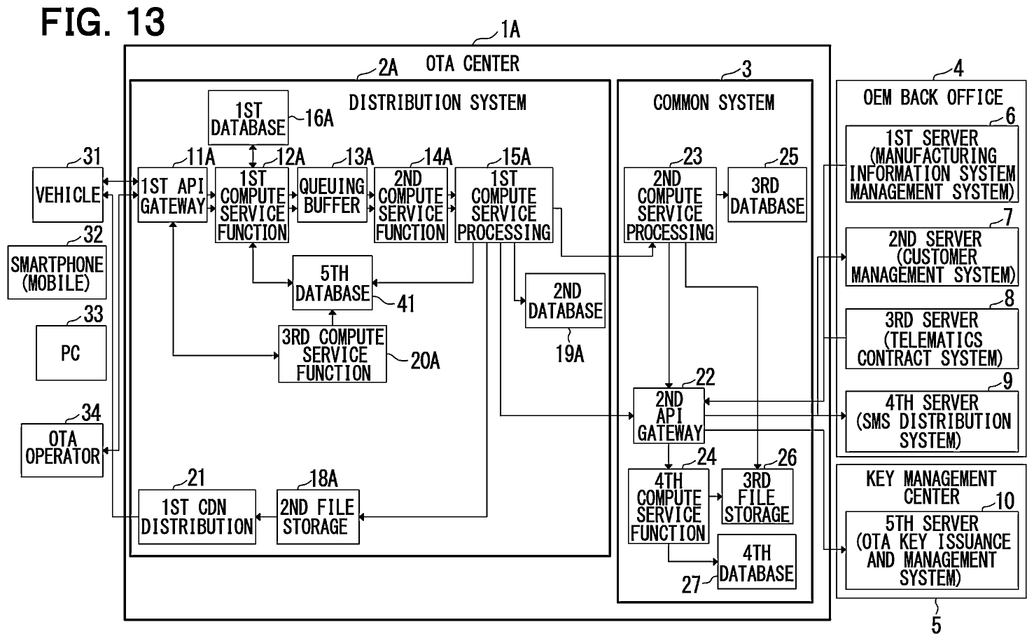

Therefore, as illustrated in FIG. 13, in an OTA center 1A according to the second embodiment, a database section 41 is disposed between a compute service function section 12A and a compute service processing section 15A in a distribution system 2A. A compute service function section 20A can access the database section 41. In the above description, the compute service function sections 12A and 20A and the database section 41 are an example of a status management section.

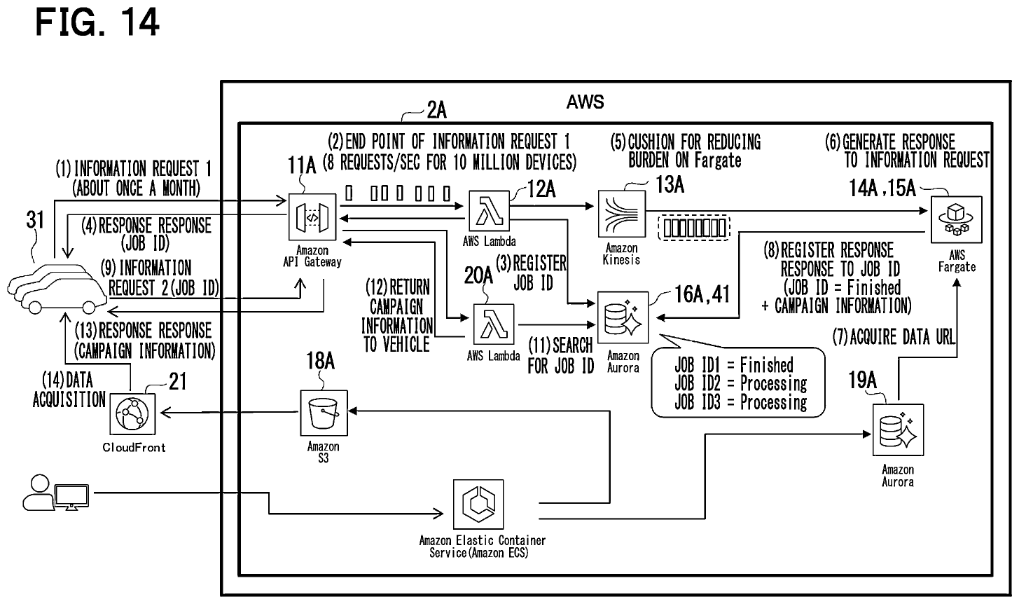

FIG. 14 is an example of a case where the configuration illustrated in FIG. 13 is configured using the AWS cloud. Amazon Aurora corresponding to the database sections 16A and 41 is disposed between AWS Lambda corresponding to the compute service function section 12A and AWS Fargate corresponding to the compute service processing section 15A, and Amazon Aurora manages the job ID. FIG. 14 illustrates an example of communication performed between the vehicle 31 and the OTA center 1.

Next, the operation of the second embodiment will be described.

### <Reception of Vehicle Configuration Information→Transmission of Job ID and Transmission of Campaign Notification Information>

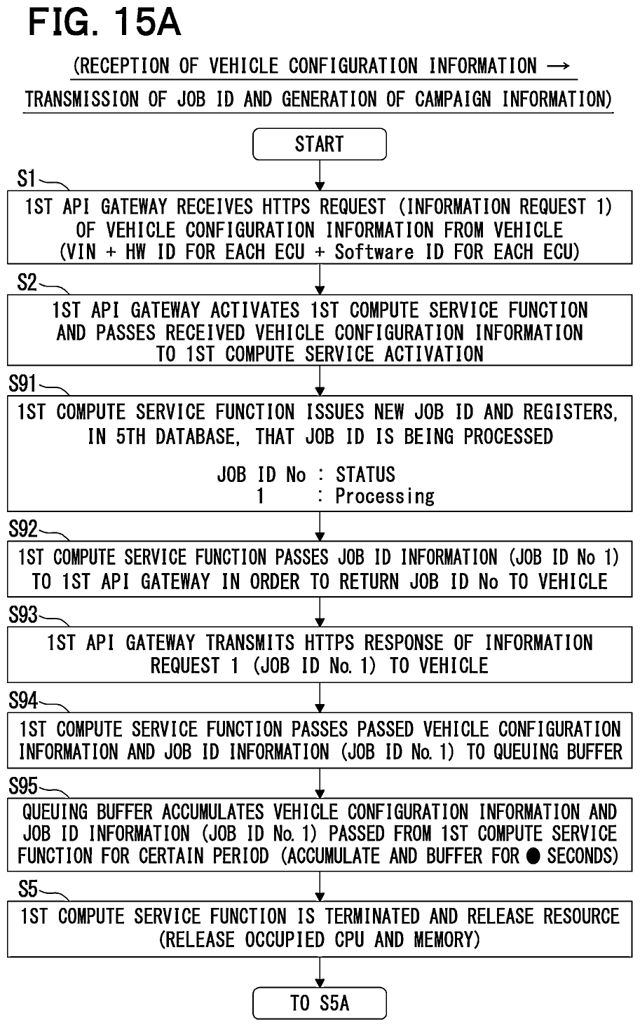

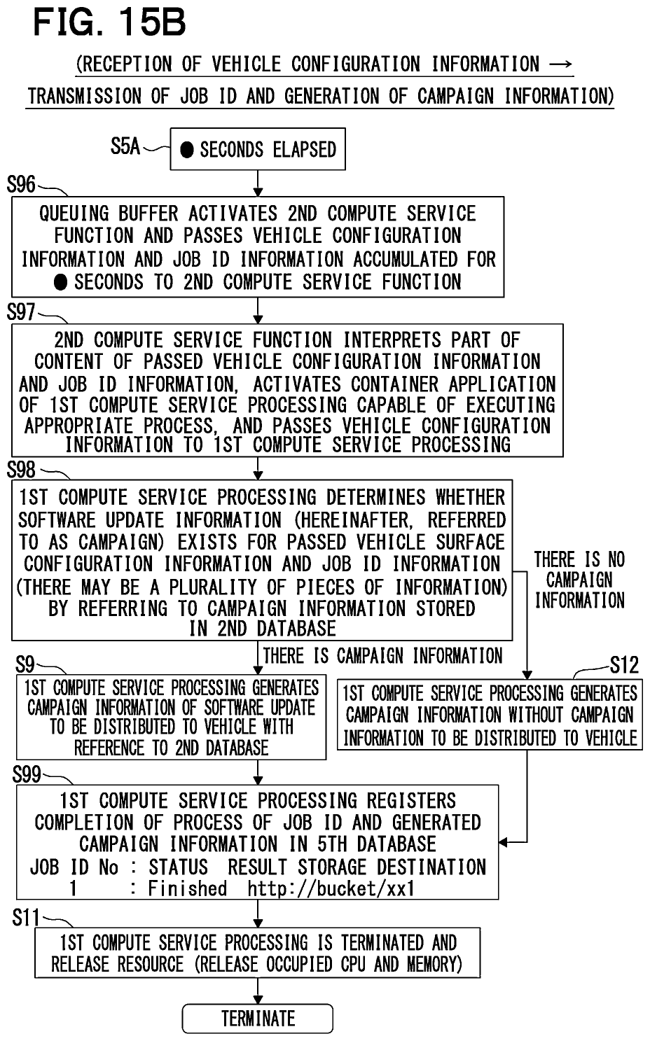

As illustrated in FIG. 15A, first, steps S1 and S2 are executed, and the request in step S1 is an “information request 1”. This request is assumed to be transmitted from one vehicle 31, for example, every two weeks or about once a month. Assuming that there is an information request 1 at a frequency of once a month from one vehicle 31, about 8 requests are transmitted per second from 10 million vehicles 31.

Subsequently, the compute service function section 12A issues a new job ID, and registers the fact that the job ID is in Processing in the database section 41 (S91). The job ID is issued for each piece of information request 1. In order to return the job ID to the vehicle 31 that is an outside of the OTA center 1A, the job ID information is passed to an API gateway section 11A. The job ID information is, for example, “Job ID No.=1” (S92). Then, the API gateway section 11A transmits an HTTPS response to the information request of the job ID information to the vehicle 31 (S93).

The compute service function section 12A passes the vehicle configuration information received from the vehicle 31 and the job ID information to the queuing buffer section 13A (S94). The queuing buffer section 13A accumulates and buffers the passed vehicle configuration information and job ID information for a certain period, for example, several seconds (S95).

When steps S5 and S5A are executed, a queuing buffer section 13A activates a compute service function section 14A and passes the vehicle configuration information and the job ID information accumulated within a certain period to the compute service function section 14A (S96). When the compute service function section 14A interprets part of the content of the passed vehicle configuration information and job ID information and activates the container application of the compute service processing section 15A capable of executing the appropriate process, the compute service function section passes the vehicle configuration information and the job ID information to the compute service processing section 15A (S97).

The compute service processing section 15A accesses a database section 19A and determines whether there is campaign information corresponding to the passed vehicle configuration information and job ID information (S98). Steps S9 and S12 are executed according to the presence or absence of the campaign information. In subsequent step S99, the compute service processing section 15A registers the fact that the process of the job ID is Finished and the generated campaign information in the database section 41. Then, when step S11 is executed, the process is terminated.

### <Reception of Campaign Information Request→Check of Generation Status of Campaign Notification Information and Transmission of Campaign Notification Information>

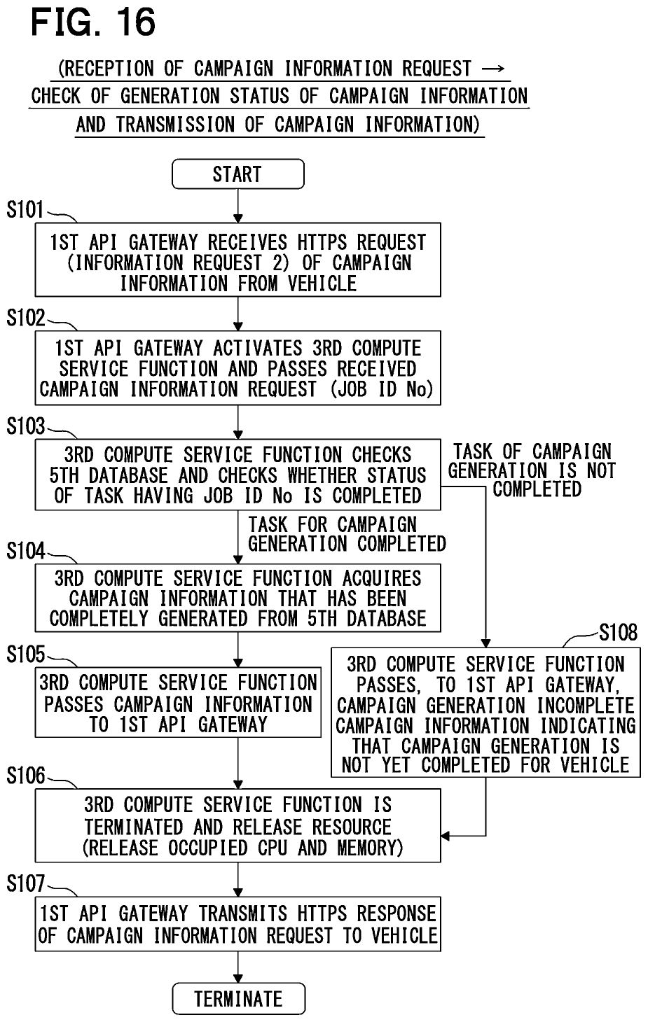

As illustrated in FIG. 16, when receiving an HTTPS request (information request 2) of the campaign information from the vehicle 31 (S101), the API gateway section 11A activates the compute service function section 20A to pass the received campaign information request (S102). The request includes a job ID number. The compute service function section 20A checks the database section 41 and checks whether the status of the generation task of the job ID number is completed (S103).

When the campaign generation task has been completed, the compute service function section 20A acquires the generated campaign notification information from the database section 41 (S104) and passes the acquired campaign information to the API gateway section 11 (S105). The compute service function section 20A terminates the process and releases the occupied resources such as the CPU and the memory (S106). The API gateway section 11 transmits an HTTPS response of the campaign information request to the vehicle 31 (S107).

On the other hand, when the task of campaign generation is incomplete, the compute service function section 20A passes the campaign notification information indicating that the generation of the campaign notification information is incomplete to the API gateway section 11A (S108), and then the process proceeds to step S106.

### <Registration of Campaign Information (Information Request 1)→Registration of Distribution Package to CDN Distribution Section 21>

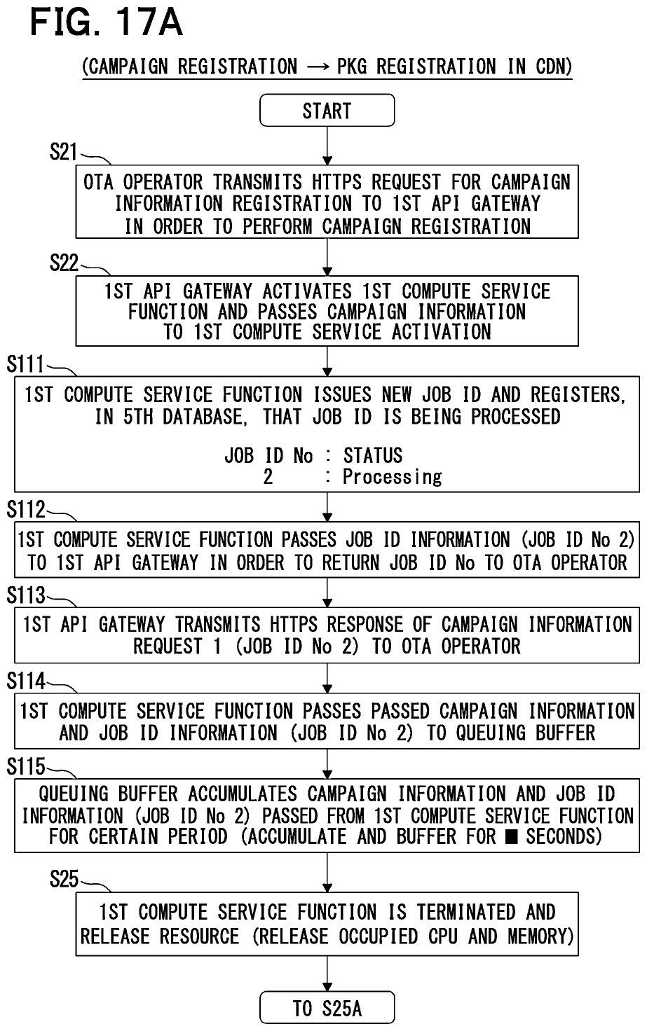

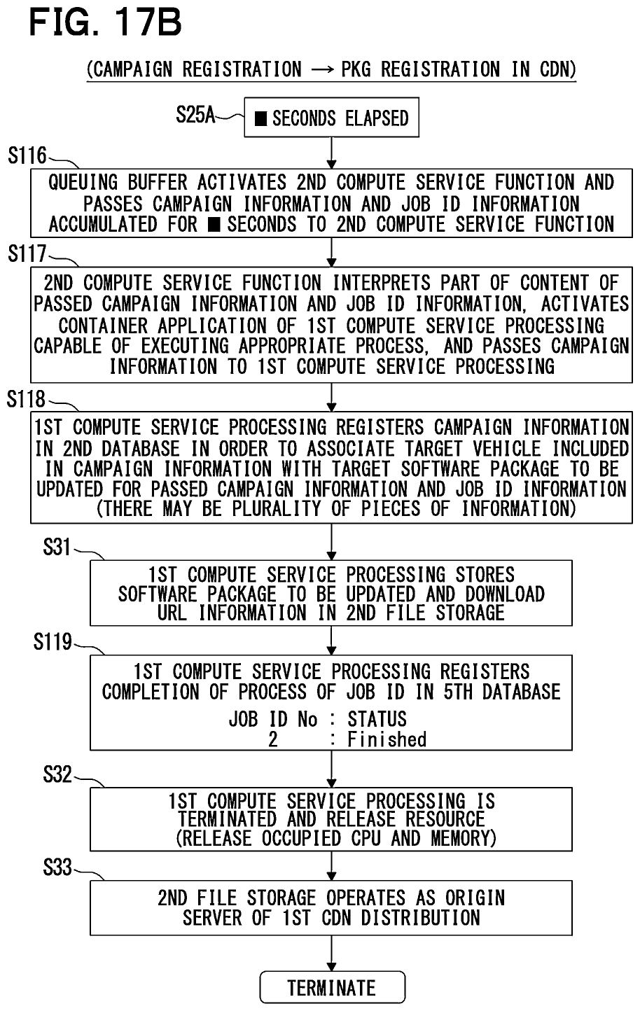

As illustrated in FIG. 17A and FIG. 17B, when steps S21 and S22 are executed (information request 1), the compute service function section 12A issues a new job ID, and registers the fact that the job ID is in processing in the database section 41 (S111). Subsequently, in order to return the job ID number to the OTA operator 34, the job ID information is passed to an API gateway section 11A (S112).

The API gateway section 11A transmits an HTTPS response of the campaign information request to the OTA operator 34 (S113). The compute service function section 12A passes the passed campaign information and job ID information to the queuing buffer section 13A (S114). The queuing buffer section 13A accumulates and buffers the passed campaign information and job ID information for a certain period (S115). Then, steps S25 and S25A are executed.

The queuing buffer section 13A activates the compute service function section 14A and passes the campaign information accumulated within a certain period and the job ID information to the compute service function section 14A (S116). When the compute service function section 14A interprets part of the content of the passed campaign information and job ID information and activates the container application of the compute service processing section 15A capable of executing the appropriate process, the compute service function section passes the campaign information to the compute service processing section 15A (S117).

The compute service processing section 15A registers the campaign information in the database section 19A in order to associate the target vehicle included in the passed campaign information and job ID information with the software package to be updated (S118). Next, the compute service processing section 15A executes steps S31, S119, S32, and S33. In step S119, the compute service processing section 15A registers completion of the process of the job ID in the database section 41.

### <Registration of Campaign Information (Information Request 2)→Registration of Distribution Package to CDN Distribution Section 21>

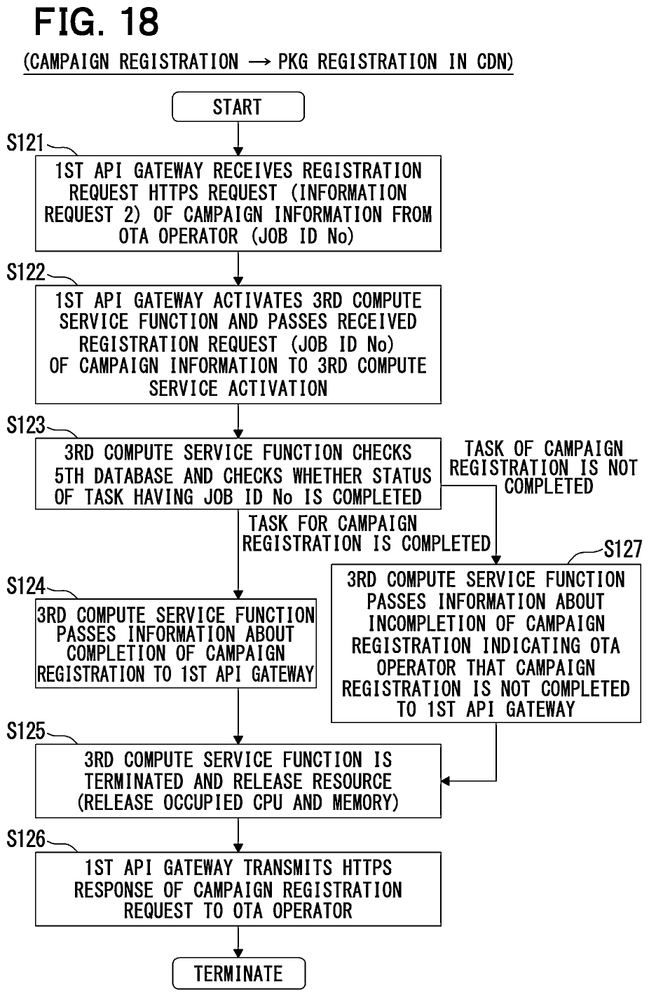

As illustrated in FIG. 18, when receiving the HTTPS request for campaign information registration from the OTA operator 34 (S121), the API gateway section 11A activates the compute service function section 20A and passes the received registration request (information request 2) (S122). The compute service function section 20A checks the database section 41 and checks whether the status of the registration task of the job ID number is completed (S123).

When the campaign registration task has been completed, the compute service function section 20A passes information indicating registration completion to the API gateway section 11A (S124). The compute service function section 20A terminates the process and releases the occupied resources such as the CPU and the memory (S125). The API gateway section 11A transmits an HTTPS response of the campaign information registration request to the OTA operator 34 (S126).

On the other hand, when the task of campaign registration is incomplete, the compute service function section 20A passes the campaign notification information indicating that the registration of the campaign information is incomplete to the API gateway section 11A (S127), and then the process proceeds to step S125.

### <Case Information (Information Request 1)→Generation of Package>

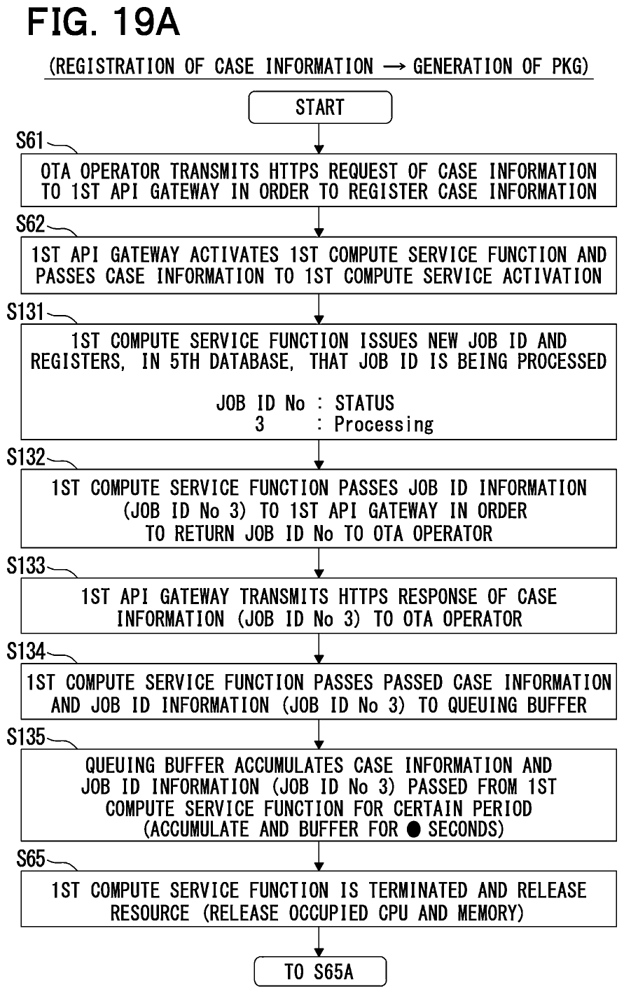

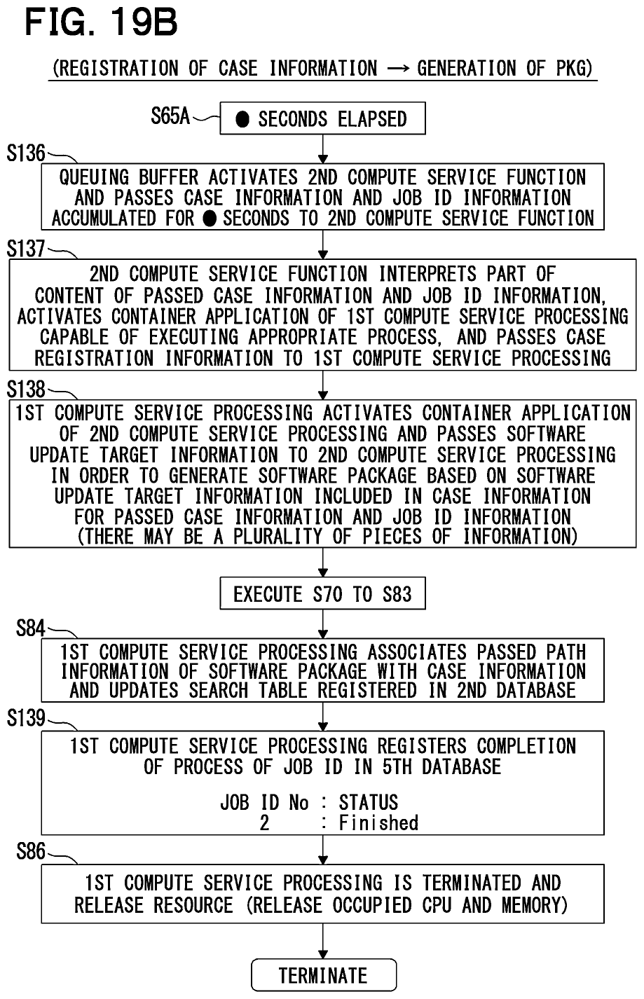

As illustrated in FIG. 19A and FIG. 19B, when steps S61 and S62 are executed (information request 1), the compute service function section 12 issues a new job ID, and registers the fact that the job ID is in processing in the database section 41 (S131). In order to return the job ID to the OTA operator 34, the job ID information is passed to the API gateway section 11 (S132). Then, the API gateway section 11 transmits an HTTPS response to the information request of the case information to the OTA operator 34 (S133).

The compute service function section 12A passes the passed case information and job ID information to the queuing buffer section 13A (S134). The queuing buffer section 13A accumulates and buffers the passed case information and job ID information for a certain period, for example, several seconds (S135).

When steps S65 and S65A are executed, the queuing buffer section 13A activates the compute service function section 14A and passes the case information and the job ID information accumulated within a certain period to the compute service function section 14A (S136). When the compute service function section 14A interprets part of the content of the passed case information and job ID information and activates the container application of the compute service processing section 15A capable of executing the appropriate process, the compute service function section passes the case information and the job ID information to the compute service processing section 15A (S137).

In order to generate a software package based on the software update information included in the passed case information, the compute service processing section 15A activates the container application of the compute service processing section 23 and passes the software update target information to the compute service processing section 23 (S138).

Thereafter, steps S70 to S86 are executed, but step S139 is executed instead of step S85. In step S139, the compute service processing section 15A registers completion of the process of the job ID in the database section 41.

### <Case Information (Information Request 2)→Generation of Package>

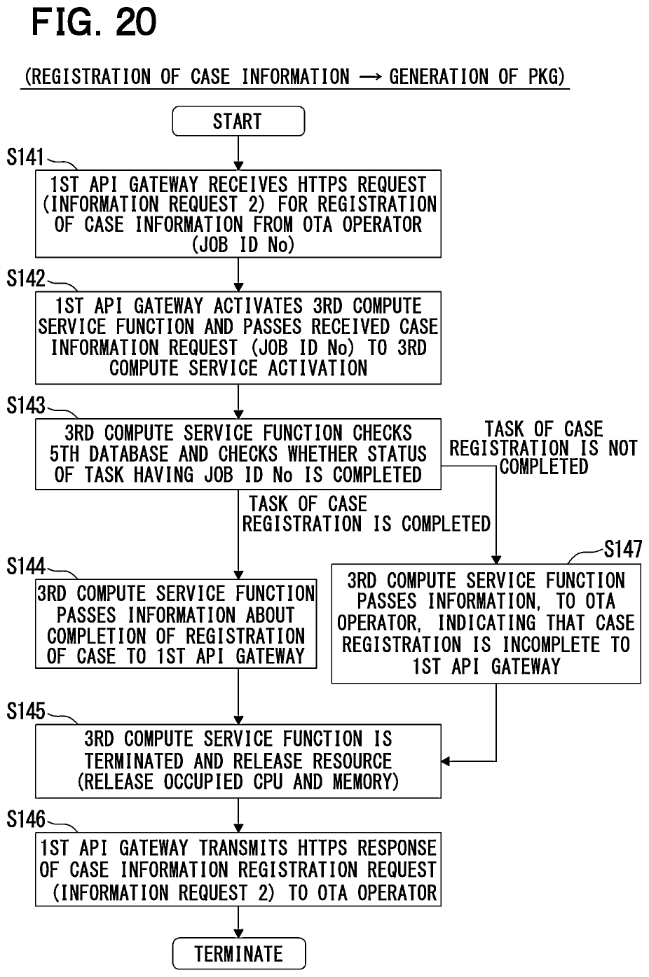

As illustrated in FIG. 20, when receiving an HTTPS request (information request 2) for registration of case information from the OTA operator 34 (S141), the API gateway section 11A activates the compute service function section 20A and passes the received request for registration of the case information (S142). The compute service function section 20A checks the database section 41 and checks whether the status of the task having the job ID number attached to the request is completed (S143).

When the task of registration of the case information has been completed, when the compute service function section 20A passes information indicating completion of registration of the case information to the API gateway section 11A (S144), then the compute service function section terminates the process and releases the occupied resources (S145). Then, the API gateway section 11A transmits an HTTPS response of the case information registration request to the OTA operator 34 (S146). On the other hand, when the task of registration of the case information is incomplete, the compute service function section 20A passes information indicating that the case information registration is incomplete, the information being to be transmitted to the OTA operator 34, to the API gateway section 11 (S147), and then the process proceeds to step S145.

As described above, according to the second embodiment, the compute service function sections 12A and 20A and the database section 41 assign the job ID information to the request received from the vehicle 31, manage the status indicating whether the process corresponding to the request is in progressing or completed, and return a response to the processed request to the vehicle 31. As a result, it is not necessary for the compute service function sections 12A and 20A to be continuously activated until the process corresponding to the request is completed, so that it is possible to enjoy more advantages obtained by adopting the serverless architecture.

### Third Embodiment

In the configuration of the second embodiment, since the communication traffic between the vehicle 31 and the API gateway section 11 of the OTA center 1A increases, there is a concern about an increase in the burden of the communication fee. Furthermore, in this configuration, when there is a design error or the like on the vehicle 31 side or the OTA center 1A side, communication retry from the vehicle 31 occurs in an infinite loop, and the OTA center 1A may fall into an overload state.

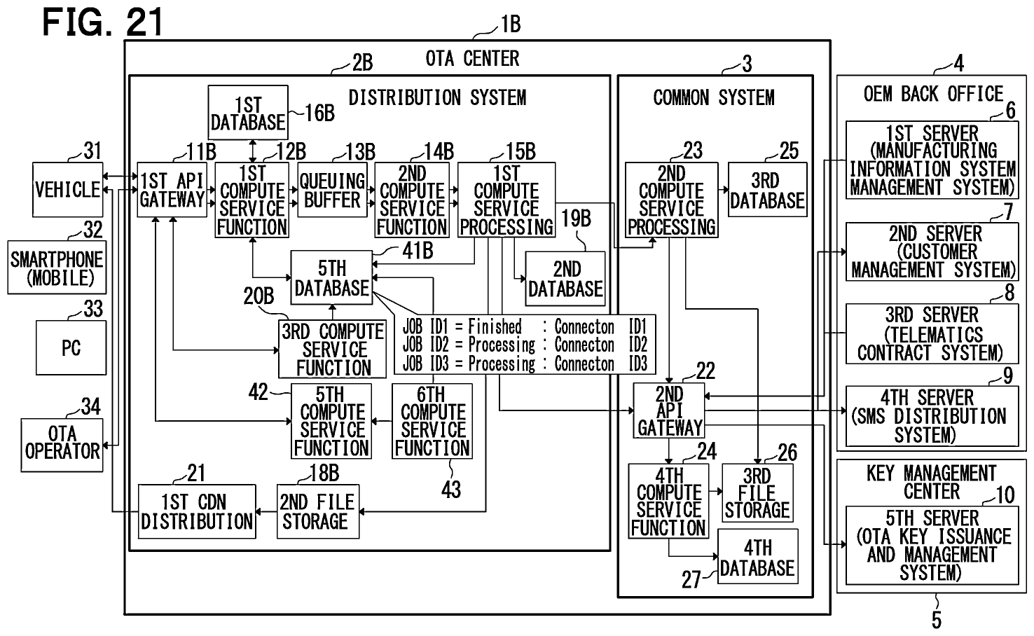

Therefore, as illustrated in FIG. 21, in an OTA center 1B of the third embodiment, compute service function sections 42 and 43 are added to the configuration of the second embodiment. The compute service function section 43 accesses the compute service function section 42 and a database section 41B, and the compute service function section 42 accesses an API gateway section 11B. In the database section 41B, the connection ID number is managed together with the job ID number and the status. A compute service function section 20B is an example of a distribution destination management section.

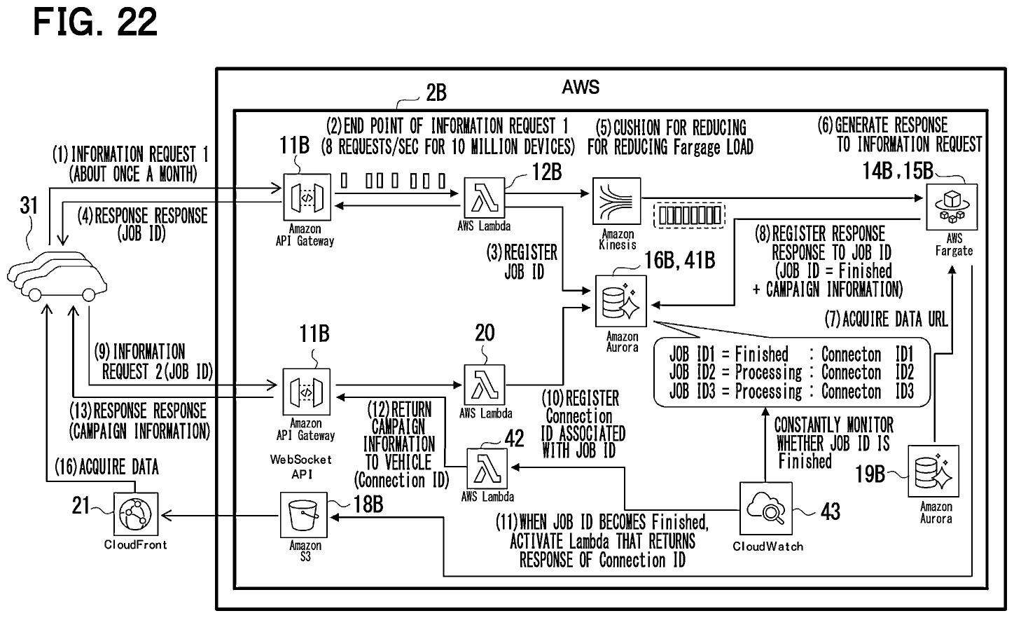

FIG. 22 is an example in which the configuration illustrated in FIG. 21 is configured using the AWS service.

Amazon API Gateway corresponds to the API gateway section 11B.
AWS Lambda: corresponds to compute service function sections 12B, 20B, and 42.

AWS Fargate corresponds to the compute service processing sections 14B and 15B.

Amazon Aurora corresponds to the database sections 19B, 25, and 27.

CloudWatch corresponds to the compute service function section 43.

Next, the operation of the third embodiment will be described.

### <Reception of Vehicle Configuration Information→Transmission of Job ID and Transmission of Campaign Notification Information>

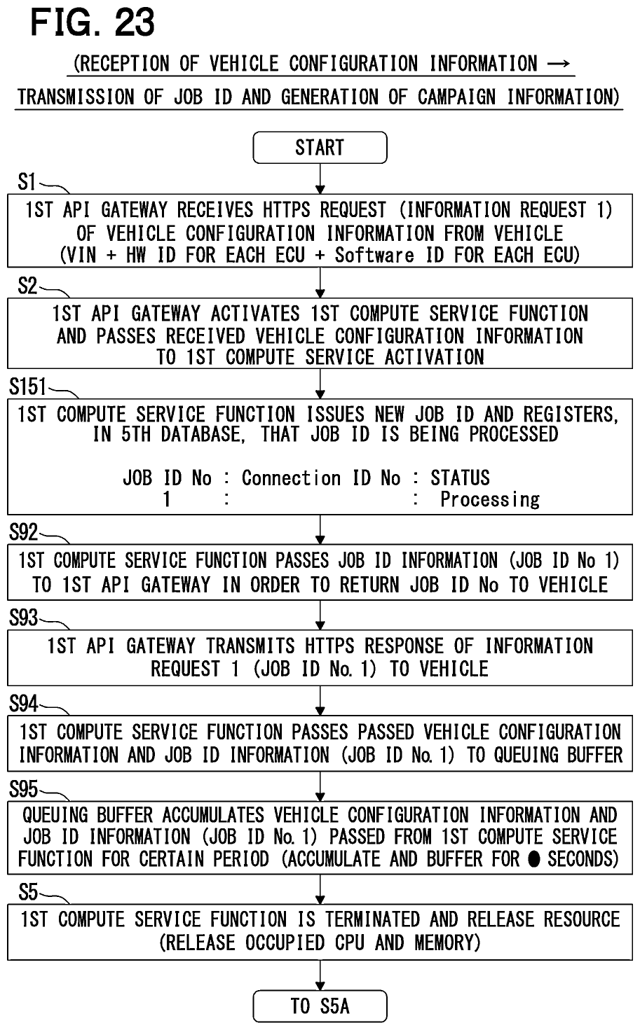

As illustrated in FIG. 23, when steps S1 and S2 are executed, the compute service function section 12B issues a new job ID, and registers the fact that the job ID is in processing and the connection ID number in the database section 41B (S151). Thereafter, steps S92 to S106 are executed. The connection ID number is a so-called TCP port number. The API gateway section 11B does not stores the job ID, but stores a connection ID number that is a TCP port number when communication with the vehicle 31 is performed.

### <Reception of Campaign Information Request→Check of Generation Status of Campaign Notification Information and Transmission of Campaign Notification Information>

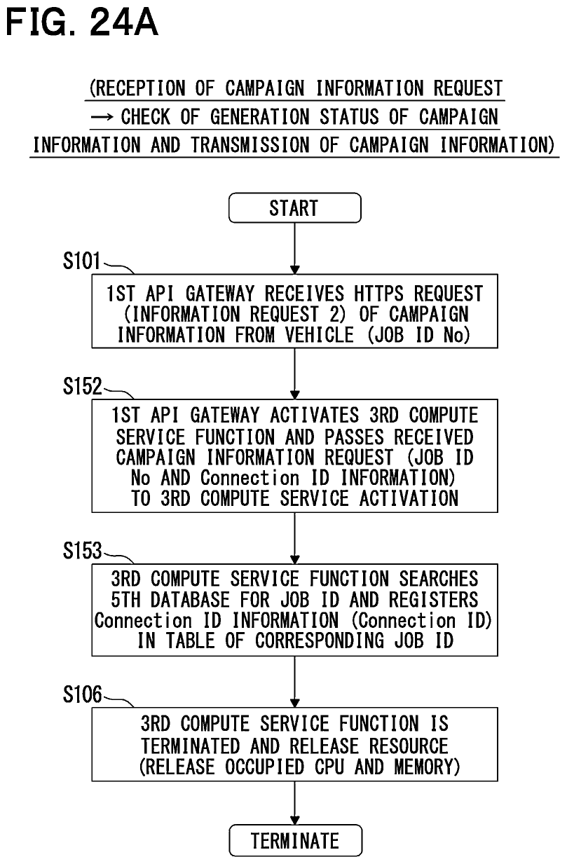

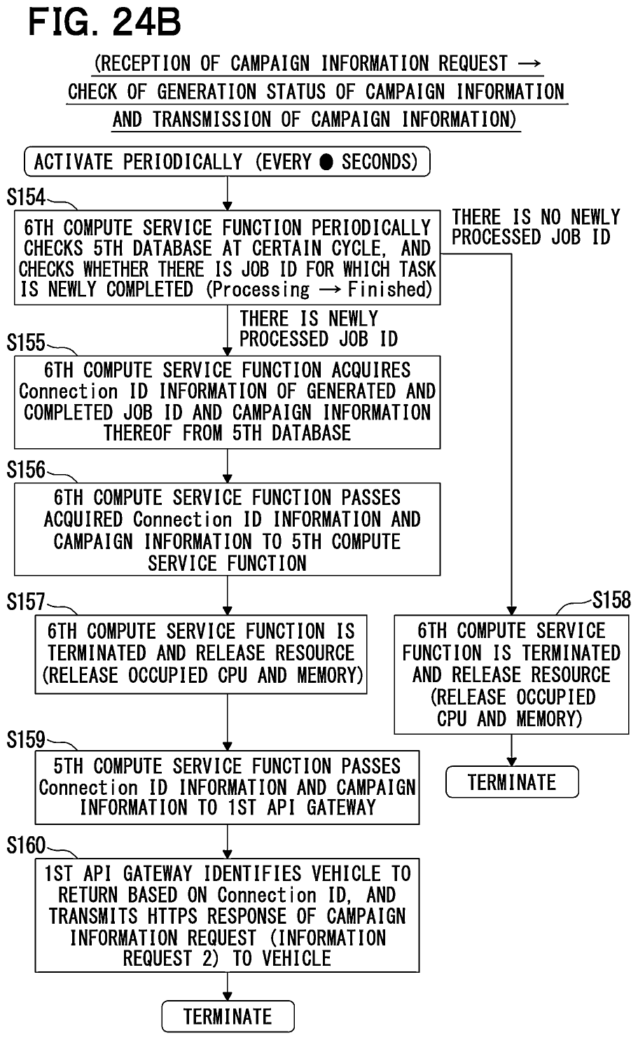

As illustrated in FIG. 24A, when executing step S101, the API gateway section 11B activates the compute service function section 20B and passes the received campaign information request (S152). The request includes connection ID information together with the job ID number. The compute service function section 20B searches the database section 41B by the job ID number, and registers the connection information in the table of the corresponding job ID number (S153). Then, step S106 is executed.

The process of steps S154 to S160 is activated periodically, for example, every several seconds. The compute service function section 43 periodically checks the database section 41B at a certain cycle, and checks whether there is a job ID number of a newly task-completed job (S154). When there is a job ID number of a task-completed job, the compute service function section 43 acquires connection ID information and campaign notification information of the job ID number from the database section 41B (S155). When passing the acquired connection ID information and campaign notification information to the compute service function section 42 (S156), the compute service function section 43 terminates the process and releases the occupied resource (S157).

Subsequently, the compute service function section 42 passes the connection ID information and the campaign notification information to the API gateway section 11B (S159). The API gateway section 11B identifies the vehicle 31 to which information is to be returned based on the connection ID information to transmit an HTTPS response to the campaign information request to the vehicle 31 (S160). On the other hand, in a case where there is no job ID number of a task-completed job in step S154, the process similar to that in step S157 is performed (S158), and then the process is terminated.

### <Registration of Campaign Information (Information Request 2)→Registration of Distribution Package to CDN Distribution Section 21>

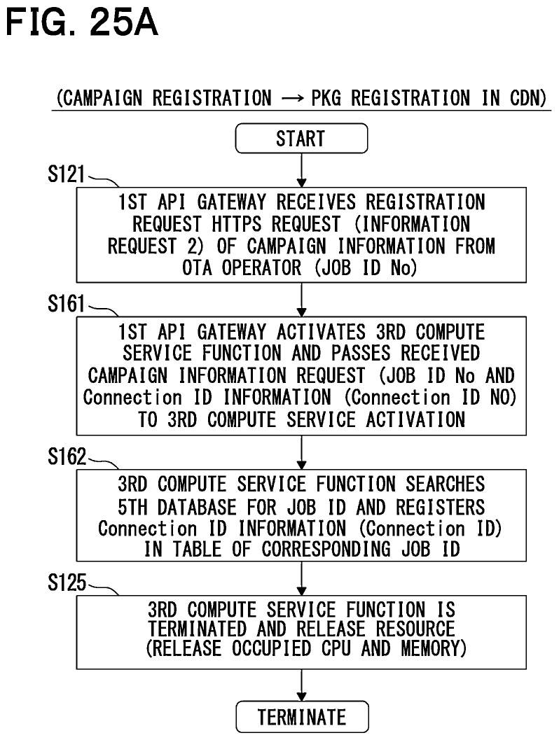

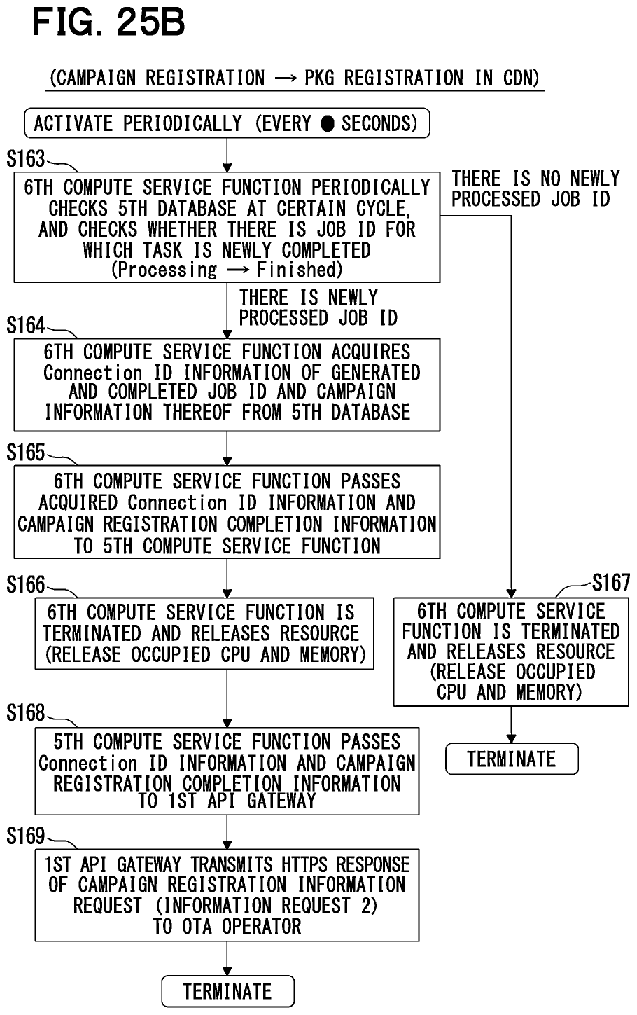

For the information request 1, steps S21 to S33 are executed as in the second embodiment. In step S91, the compute service function section 12A issues a new job ID, and registers the fact that the job ID is in Processing and the connection ID number in the database section 41. Then, as illustrated in FIG. 25A and FIG. 25B, when executing step S121, the API gateway section 11B executes the process similar to that of steps S152 and S153 (S161, S162), and then executes step S125. The process of steps S163 to S169 is similar to the process of steps S154 to S160, but the transmission destination of the response in step S169 is the OTA operator 34.

<Data access from vehicle→Transmit Distribution Package From CDN to Vehicle>

### <Registration of Software Update Data>

These processes are similar to those in the first embodiment.

### <Registration of Case Information and Generation of Package>

This process is similar to that of the second embodiment.

### <Reception of Registration Request of Case Information→Check of Registration Status of Case Information and Transmission of Case Registration Information (Result)>

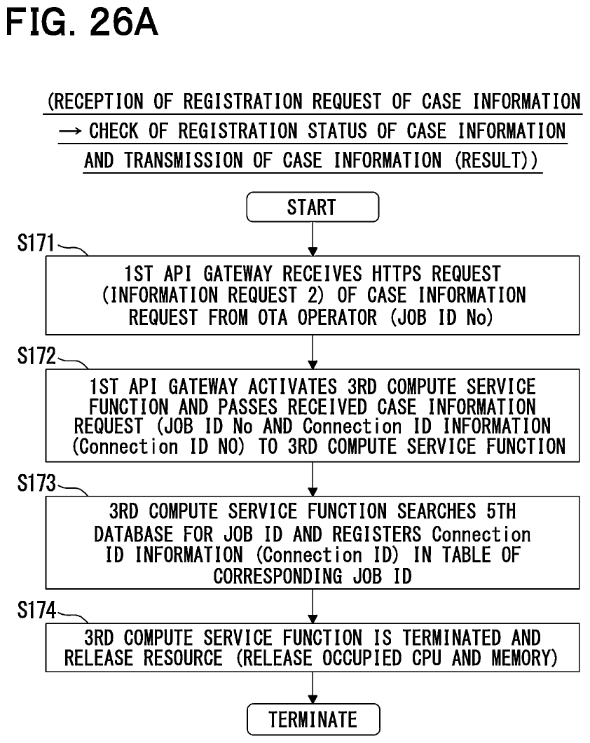

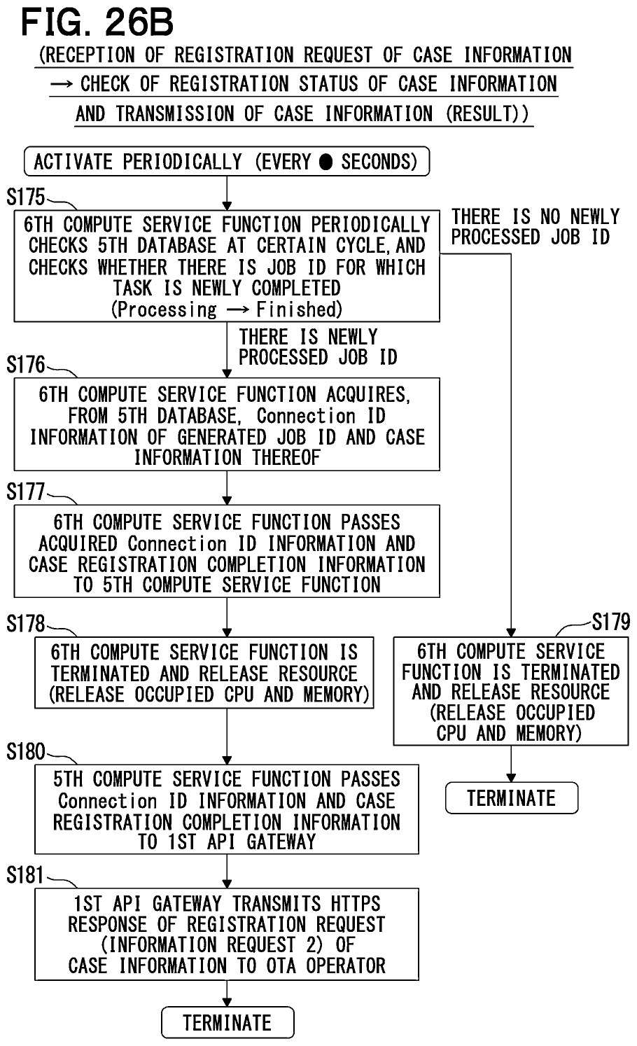

As illustrated in FIG. 26A and FIG. 26B, the process of steps S171 and S172 is similar to that of steps S141 and S142, but the information to be passed to the compute service function section 20B includes connection ID information. In the process of steps S173 to S181, the process of steps S153 to S160 illustrated in FIG. 24A and FIG. 24B is performed for the case information instead of the campaign information.

As described above, according to the third embodiment, when receiving a request to which a job number is assigned from the vehicle 31 or the OTA operator 34, the compute service function section 20B assigns a connection number associated with the job number and registers the request in the database section 41B, and when there is a request for which process has been completed by referring to the database section 41, the compute service function sections 42 and 43 identify the vehicle 31 or the OTA operator 34 as a transmission destination of a response based on the connection number corresponding to the job number of the request to transmit the response to the identified vehicle 31 or OTA operator 34 via the API gateway section 11B. As a result, since the vehicle 31 or the OTA operator 34 checks with the API gateway section 11B whether the process of the job number is completed, a process of repeatedly transmitting a request is not necessary, and the communication occurring in the second embodiment can be reduced, so that the amount of communication traffic between the vehicle 31 or the OTA operator 34 and the API gateway section 11B can be reduced.

### Fourth Embodiment

Regarding the configuration of the third embodiment, it is assumed that the processing load of AWS Fagate corresponding to the compute service processing section 15B disposed at the subsequent stage of the queuing buffer section 13B is adjusted by autoscaling. In this case, normally, using a target tracking scaling policy or the like of an elastic container service (ECS), the number of tasks or the like is controlled by using a CloudWatch metrics and an alarm in the ECS.

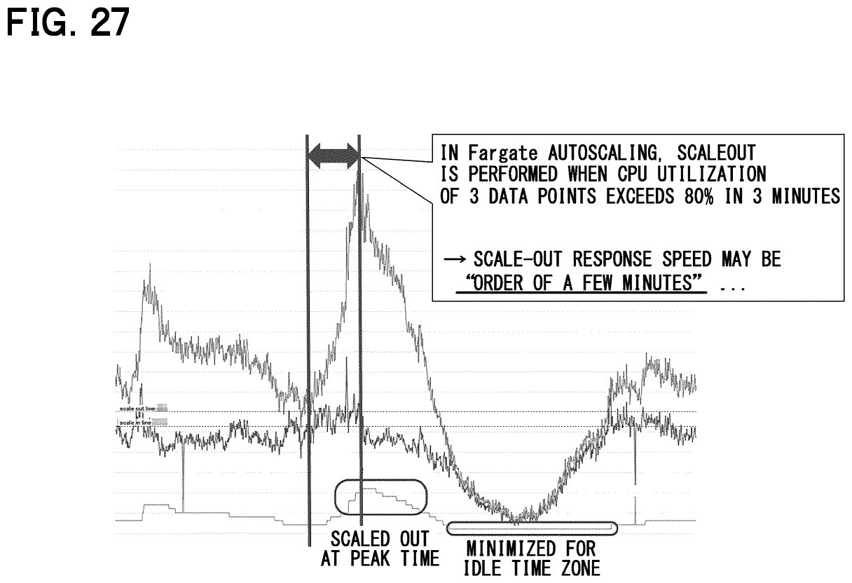

Since there is constantly a time lag between the CloudWatch metrics and alarm activation, it is difficult to perform scaling in units of several seconds, and scaling in units of minutes is basically performed. For this reason, in the serverless application simply applying AWS Fargate, as illustrated in FIG. 27, there is a problem that it is not possible to cope with a sudden rapid increase in communication traffic from the vehicle 31.

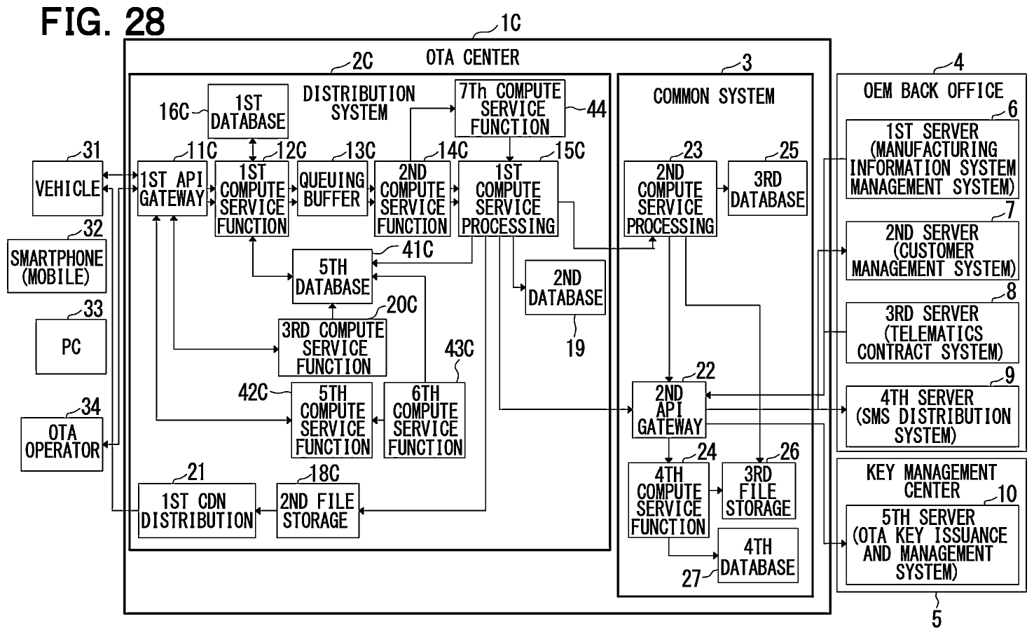

Therefore, in an OTA center 1C of the fourth embodiment illustrated in FIG. 28, a compute service function section 44 is added to the configuration of the third embodiment in a distribution system 2C. A compute service function section 14C accesses the compute service function section 44, and the compute service function section 44 accesses a compute service processing section 15C.

The compute service function section 44 actively performs scale-out. In order to autoscale AWS Fargate corresponding to the compute service processing section 15C at high speed, for example, the number of connections to the Fargate task that is a data plane is acquired every 3 seconds using Step Functions, and the upper limit of the number of tasks of the ECS that is a control plane is increased according to the result. As a result, the processing capability of the compute service processing section 15C is adjusted. The compute service function section 44 is an example of a processing capability adjustment section.

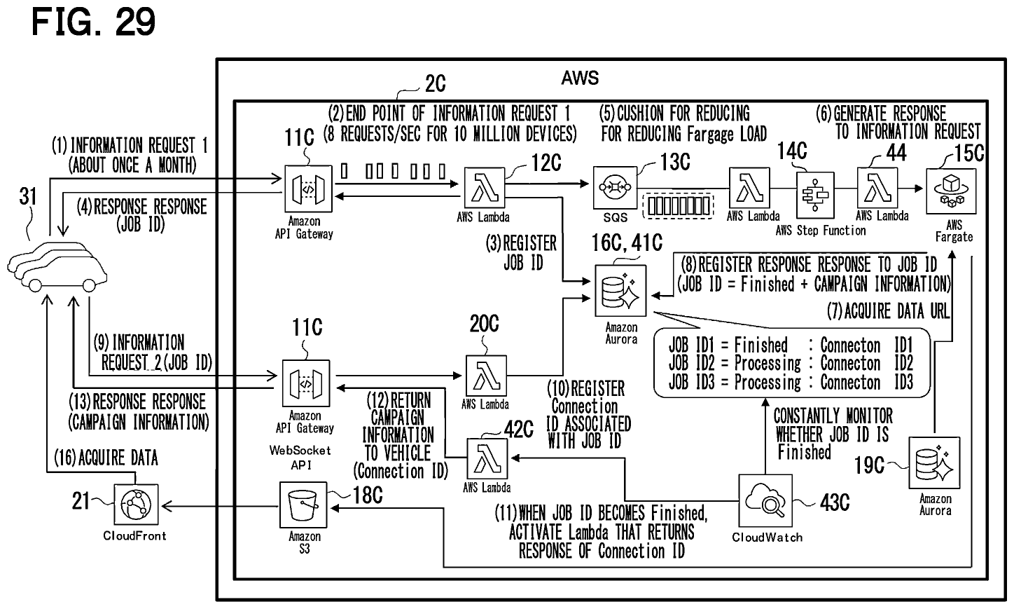

FIG. 29 is an example of a case where a center device 1C illustrated in FIG. 28 is configured using the AWS cloud.

Amazon API Gateway corresponds to an API gateway section 11C.

AWS Lambda corresponds to compute service function sections 120, 20C, 42C, and 44.

SQS corresponds to a queuing buffer section 13C.

AWS Step Functions corresponds to the compute service function section 14C.

Amazon Aurora corresponds to database sections 16C and 41C.

CloudWatch corresponds to a compute service function section 43C.

Next, the operation of the fourth embodiment will be described.

### <Reception of Vehicle Configuration Information→Transmission of JOB_ID and Generation of Campaign Notification Information>

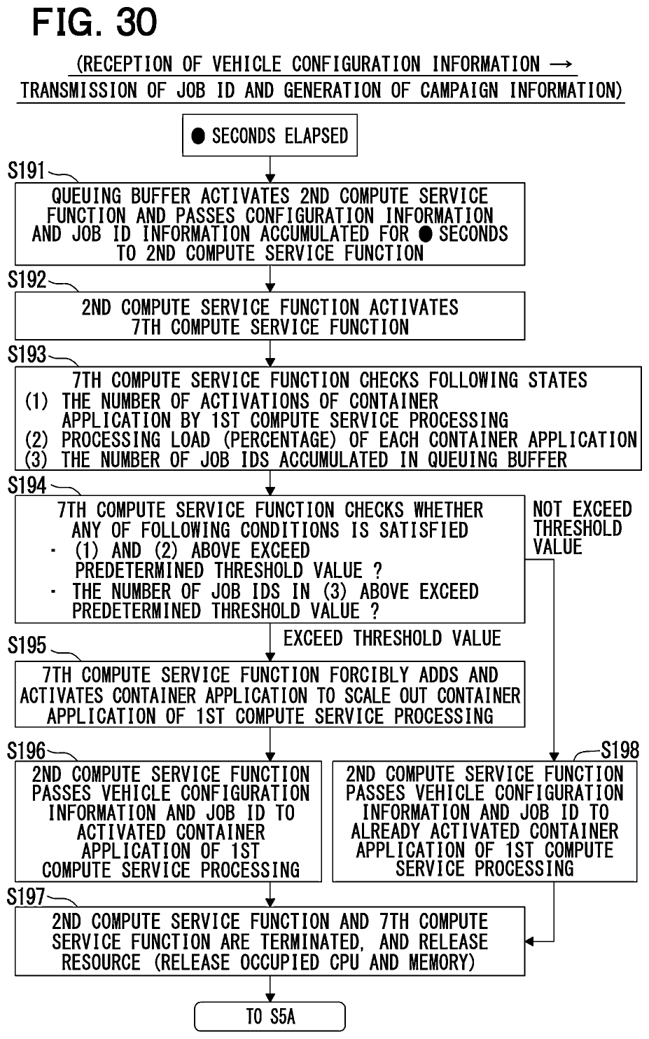

Steps S1 to S5A are executed as in the second embodiment illustrated in FIG. 15A and FIG. 15B. Subsequently, as illustrated in FIG. 30, when the process similar to that of step S96 is executed (S191), the compute service function section 14C activates the compute service function section 44 (S192). The compute service function section 44 checks the following (1) to (3) (S192):
(1) The number of container applications in the compute service processing section 150;
(2) The processing load factor of each container application; and
(3) The number of job IDs accumulated in the queuing buffer section 13C.

Subsequently, the compute service function section 44 checks whether any of the following conditions is satisfied (S194):
The number of activations in the above (1) exceeds a predetermined threshold value;
The load factor of the above (2) exceeds a predetermined threshold value; and
The number of job IDs in (3) above exceeds a predetermined threshold value.

When any of the conditions exceeds the threshold value, the compute service function section 44 forcibly adds and activates the container application in order to scale out the container application of the compute service processing section 15C (S195).

Next, the compute service function section 14C passes the vehicle configuration information and the job ID to the activated container application of the compute service processing section 15C (S196). Then, the compute service function sections 14C and 44 terminate the process and release the occupied resources (S197). On the other hand, in step S194, when the value does not exceed the threshold value under any condition, the compute service function section 14C passes the vehicle configuration information and the job ID to the already activated container application of the compute service processing section 15C (S198), and then the process proceeds to step S197. Thereafter, steps S98 to S11 illustrated in FIG. 15 are executed.

A process of transmitting JOB_ID and generating campaign notification information from transmission and reception of vehicle configuration information is described as an example, but the present disclosure can be applied to all processes in which scale-out of the compute service processing sections 15A and 15B is assumed.

As described above, according to the fourth embodiment, when checking the processing load of the compute service processing section 15C configured to generate the campaign notification information for the vehicle 31 and the number of pieces of vehicle configuration information received from the vehicle 31, the compute service function section 44 determines whether it is necessary to increase or decrease the processing capability of the compute service processing section 15C, and increases or decreases the processing capability as necessary. As a result, it is possible to cope with a case where the amount of communication traffic with the vehicle 31 or the OTA operator 34 rapidly increases.

### Fifth Embodiment

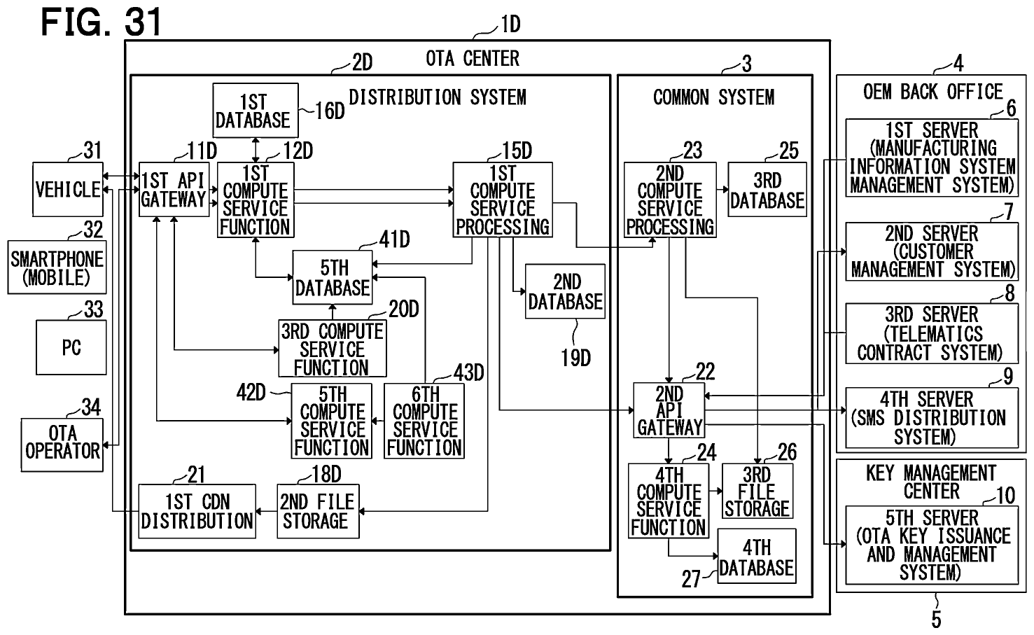

In the fifth embodiment, a configuration in which the development cost is optimized is illustrated. As illustrated in FIG. 31, in an OTA center 1D of the fifth embodiment, the queuing buffer section 13 and the compute service function section 14 are deleted from the configuration of the second embodiment in a distribution center 2D.

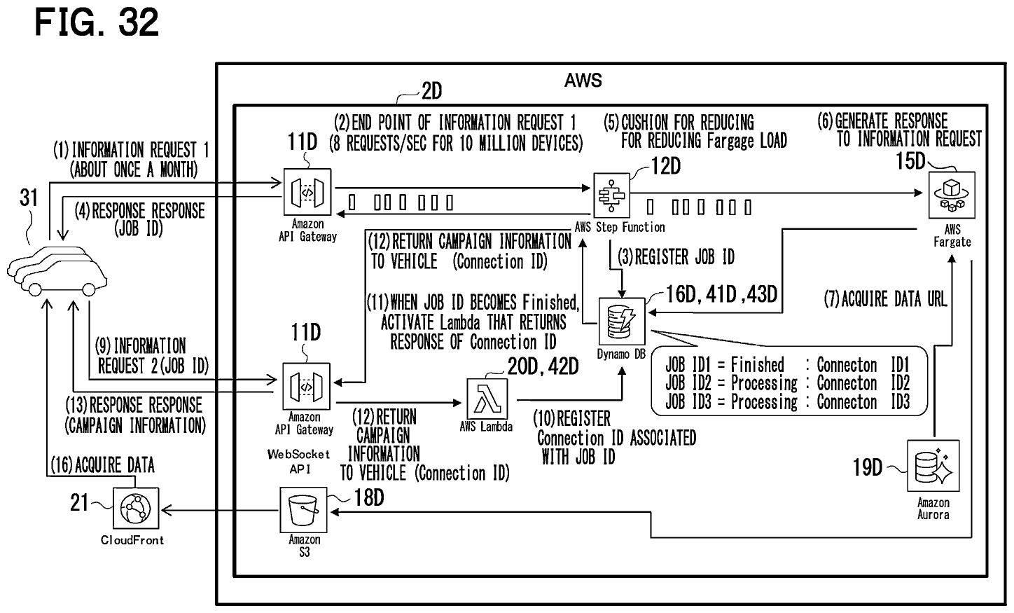

FIG. 32 is an example of a case where a center device 1D illustrated in FIG. 31 is configured using the AWS cloud.

Amazon API Gateway corresponds to an API gateway section 11D.

AWS Lambda corresponds to compute service function sections 20D and 42D.

AWS Step Functions corresponds to a compute service function section 12D.

Dynamo DB corresponds to database sections 16D and 41D, and a compute service function section 43D.

Next, the operation of the fifth embodiment will be described.

### <Reception of Vehicle Configuration Information→Transmission of Job ID and Transmission of Campaign Notification Information>

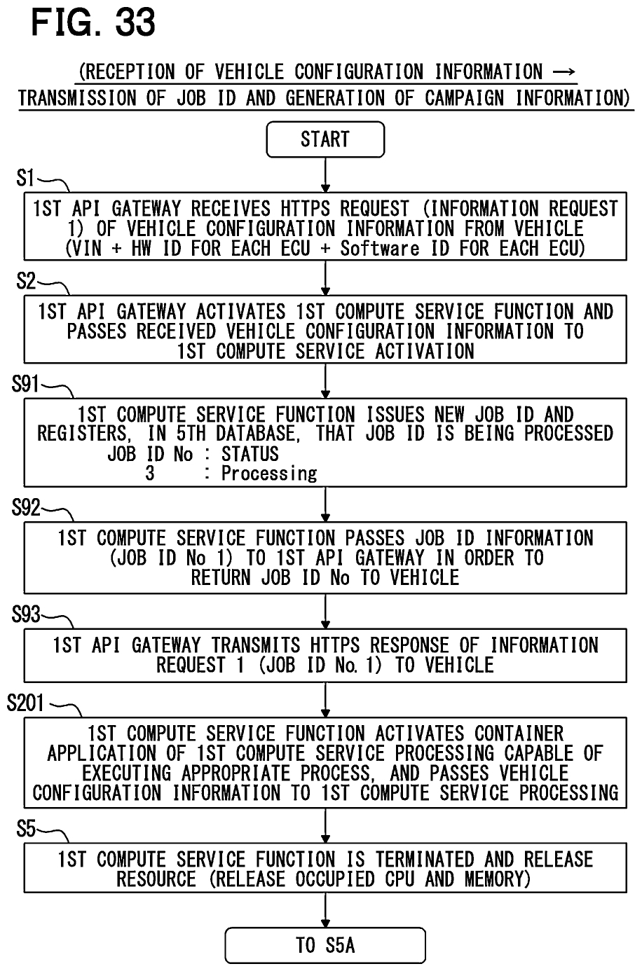

As illustrated in FIG. 33, when steps S1 to S93 are executed, the compute service function section 12D activates a container application of a compute service processing section 15D capable of executing the appropriate process, and passes the vehicle configuration information to the compute service processing section 15D (S201). Then, steps S5 to S11 are executed.

### <Reception of Campaign Information Request→Check of Generation Status of Campaign Information and Transmission of Campaign Notification Information>

This is similar to the processing illustrated in FIG. 24A and FIG. 24B of the third embodiment.

### <Registration of Campaign Information→Registration of Distribution Package to CDN Distribution Section 21D>

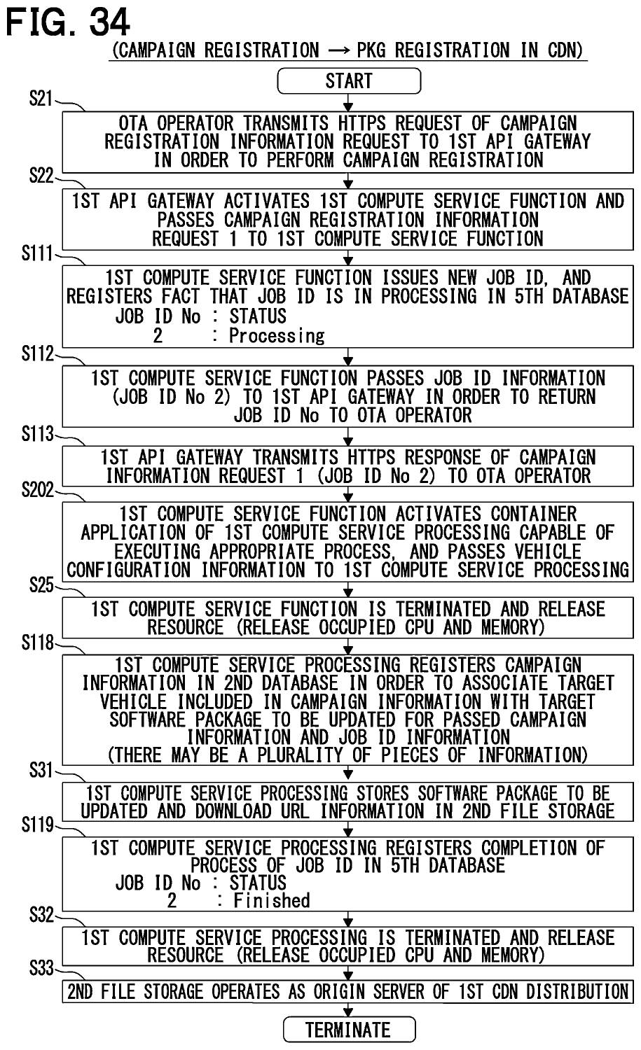

As illustrated in FIG. 34, when steps S21 to S113 are executed, the compute service function section 12D activates a container application of the compute service processing section 15D capable of executing the appropriate process, and passes the vehicle configuration information to a compute service processing section 15DD (S202). Then, steps S25, S118, and S31 to S33 are executed.

### <Registration of Campaign Information→Registration of Distribution Package to CDN Distribution Section 21>

This is similar to the processing illustrated in FIG. 25A and FIG. 25B of the second embodiment.

### <Data Access From Vehicle→Transmit Distribution Package From CDN to Vehicle>

This is similar to the processing illustrated in FIG. 6 of the first embodiment.

### <Registration of Software Update Data>

This is similar to the processing illustrated in FIG. 7 of the first embodiment.

### <Registration of Case Information→Generation of Package>

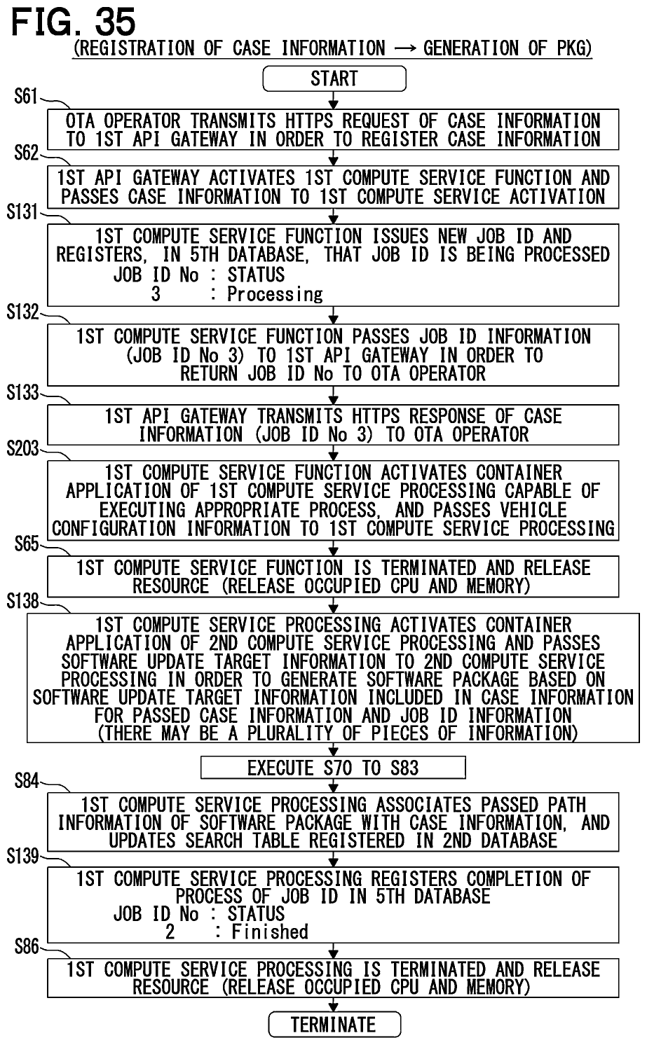

As illustrated in FIG. 35, when steps S61 to S133 are executed as in FIG. 19A of the second embodiment, the compute service function section 12D activates the container application of the compute service processing section 15D capable of executing the appropriate process, and passes the vehicle configuration information to the compute service processing section 15D (S203). Then, when steps S65 and S138 are executed, S70 to S86 are executed as in FIG. 19B of the second embodiment.

### <Reception of Registration Request of Case Information→Check of Registration Status of Case Information and Transmission of Case Registration Information (Result)>

This is similar to the processing illustrated in FIG. 26A and FIG. 26B of the third embodiment.

As described above, according to the fifth embodiment, the OTA center 1D can be configured at low cost by deleting the queuing buffer section 13 and the compute service function section 14.

### Sixth Embodiment

In the sixth embodiment, in order to enhance security, a signed URL having an expiration date is used. By using the signed URL, a start date and time at which the user can start accessing the content, a date and time or a period of time when the user can access the content, can be designated, and an IP address of the user who can access the content or a range of the IP addresses can be designated. The signature is an example of the access control information.

For example, when the OTA center creates a signed URL using the secret key and returns the signed URL to the vehicle, the vehicle side downloads or streams content from the CDN using the signed URL. The CDN verify the signature using a public key, and verify that the user is qualified to access the file.

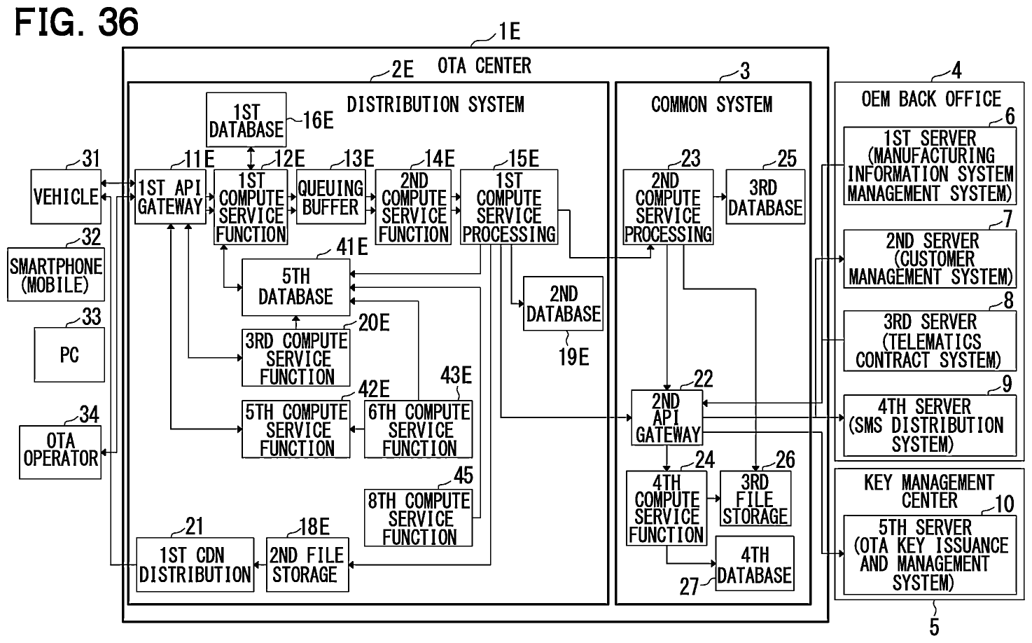

As illustrated in FIG. 36, an OTA center 1E of the sixth embodiment is obtained by adding a compute service function section 45 to the configuration of the second embodiment in a distribution system 2E. The compute service function section 45 accesses a compute service processing section 15E. A database section 41E manages an expiration date and a signed URL.

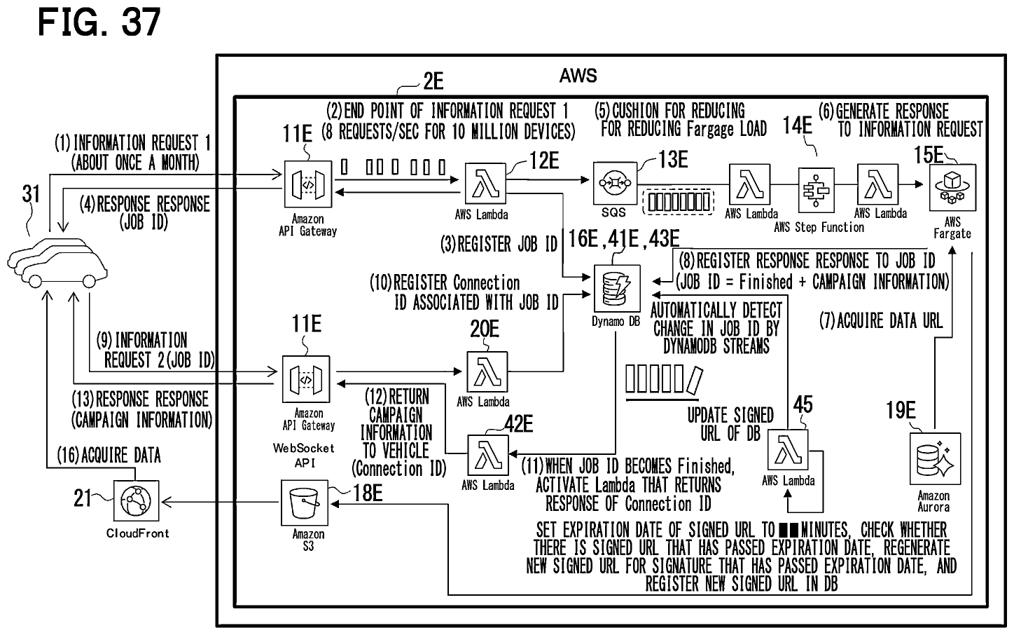

FIG. 37 is an example of a case where the center device 1E illustrated in FIG. 36 is configured using the AWS cloud.

Amazon API Gateway corresponds to the API gateway section 11E.

AWS Lambda corresponds to compute service function sections 12E, 14E, 20E, and 45.

AWS Step Functions corresponds to a compute service function section 14E.

SQS corresponds to the queuing buffer section 13E.

Dynamo DB corresponds to the database sections 16E and 41E and the compute service function section 42E.

Next, the operation of the sixth embodiment will be described.

### <Reception of Vehicle Configuration Information→Transmission of Job ID and Transmission of Campaign Notification Information>

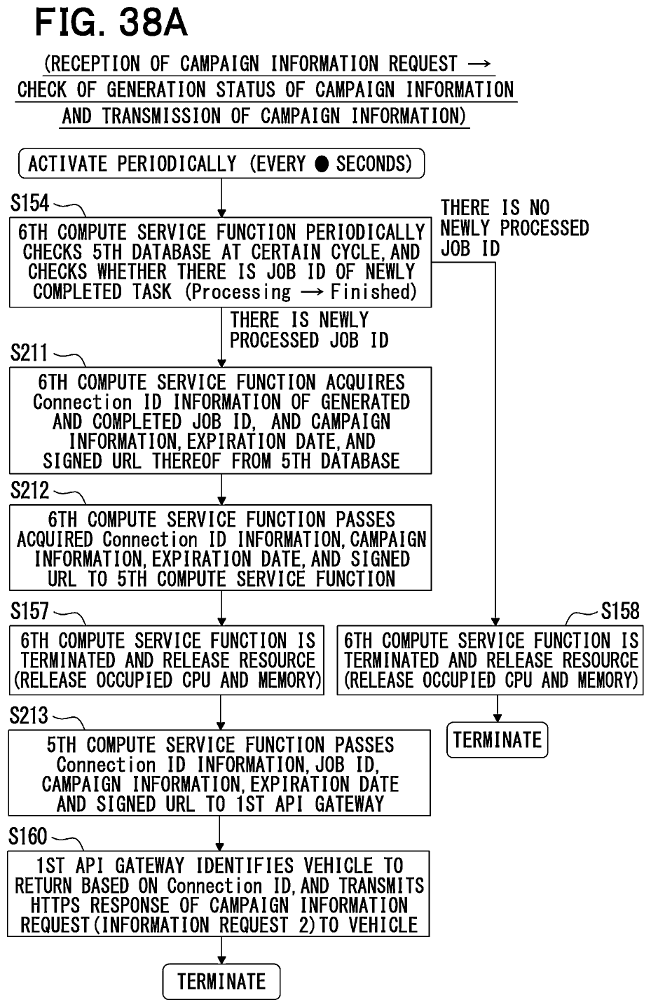

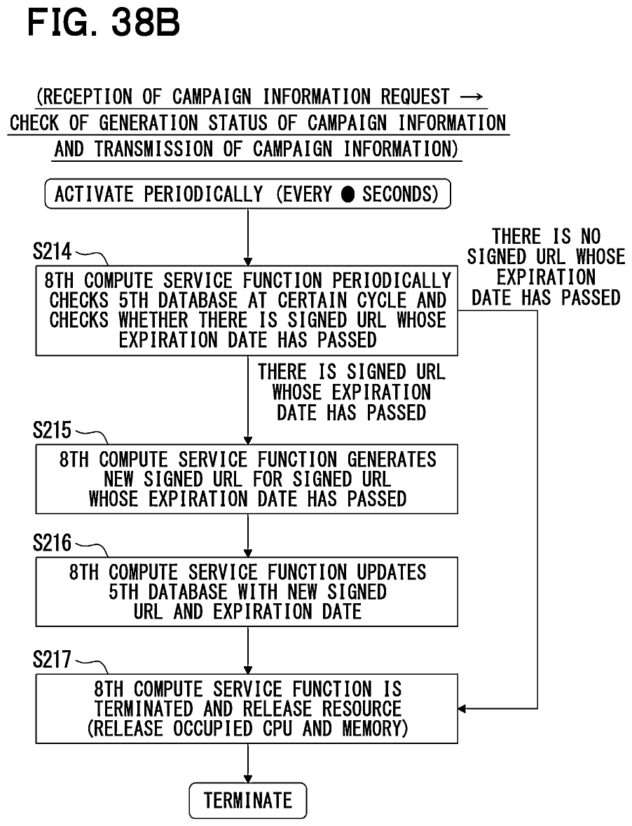

First, steps S1 to S5 and steps S92 to S11 are executed as in the processing illustrated in FIG. 23 of the third embodiment. Subsequently, steps S101 to S106 are executed as in the processing illustrated in FIG. 24. Then, as illustrated in FIG. 38A and FIG. 38B, when step S154 is executed, when there is a job ID number of a task-completed job, a compute service function section 43E acquires connection ID information and campaign notification information of the job ID number, and an expiration date and a signed URL from the database section 41E (S211). When each piece of the acquired information is passed to a compute service function section 42E (S212), step S157 is executed. The compute service function section 42E passes each of the above information to the API gateway section 11E (S213), and then executes step S160.

The process of steps S214 to S217 is periodically executed. The compute service function section 45 periodically checks the database section 41E to check whether there is a signed URL whose expiration date has passed (S214). When there is a signed URL whose expiration date has passed, a signed URL to which a new expiration date is added is generated (S215), and the database section 41E is updated (S216). Then, the compute service function section 45 terminates the process and releases the occupied resource (S217).

### <Registration of Campaign Information→Registration of Distribution Package to CDN Distribution Section 21>

This process is similar to that of the third embodiment.

### <Data Access From Vehicle→Transmit Distribution Package From CDN to Vehicle>

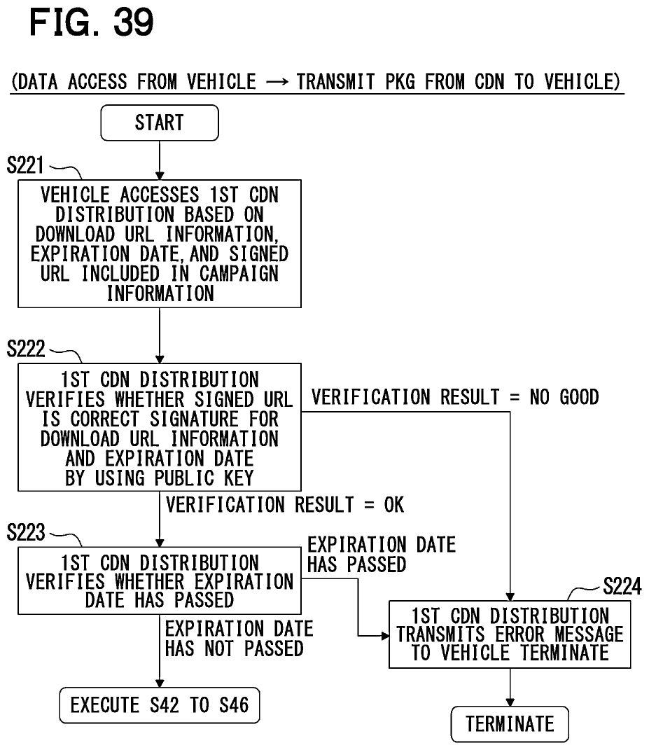

As illustrated in FIG. 39, the vehicle 31 accesses the CDN distribution section 21 based on the download URL information, the expiration date, and the signed URL included in the campaign notification information (S221). The CDN distribution section 21 verifies whether the expiration date and the signature of the signed URL are correct using the public key (S222). When the verification result is OK, the CDN distribution section 21 verifies whether the expiration date has passed (S223), and executes steps S42 to S46 when the expiration date has not passed. On the other hand, when the expiration date has passed, the CDN distribution section 21 transmits an error message to the vehicle 31 (S224).

### <Registration of Software Update Data>

### <Registration of Case Information→Generation of Package>

### <Reception of Case Information Registration Request→Check of Generation Status of Case Information and Transmission of Case Information>

These processes are similar to those in the third embodiment.

As described above, according to the sixth embodiment, since the campaign notification information includes the expiration date and the signed URL in together with the download URL information, and the OTA center 1E checks the expiration date and verifies the signature, it is possible to assign the date and time when the access to the content can be started and the date and time when the access can be made, and to limit the users who can access the content by the CDN distribution section 21. Therefore, the security of communication with the vehicle 31 can be improved.

### Seventh Embodiment

In the above embodiment, the case where the serverless architecture is adopted in the OTA center is described. The OTA center is assumed to communicate with a vehicle, a PC, a smartphone, an OTA operator, an OEM back office, and a key management center. A server architecture may be adopted for at least part of processing, determination, and management among the functions of the OTA center.

For example, in a case where a certain system has been developed on the premise of a server architecture, it is conceivable that there is a verified program after design and implementation and a module also referred to as a development asset. In such a case, when all of the system is reconstructed as a serverless architecture, assets such as developed programs and modules, knowledge regarding development, and the like cannot be used. In such a situation, there is a possibility of causing an increase in development cost and an increase in development period.

The inventors of the present application have focused on effectively utilizing the past developed assets while receiving the merit of the serverless architecture by combining the process of adopting the serverless architecture and the process of adopting the server architecture in the system. The serverless architecture is advantageous for processing in which the number of requests from the outside fluctuates greatly. Specifically, the number of requests to be processed from a vehicle, a PC, and a smartphone, which will be hereinafter referred to as a vehicle or the like, varies greatly depending on the region, the time zone, the vehicle price range, and the like. On the other hand, the number of requests to be processed from an OTA operator, an OEM back office, and a key management center, which will be hereinafter referred to as an OTA operator or the like, is smaller than the number of requests from the vehicle or the like, and the variation in the number of requests tends to be small.

Therefore, in the seventh embodiment, a serverless architecture is used for processing based on a request from the vehicle or the like. A server architecture is used for processing based on a request from the OTA operator or the like. Details of operations in a case where the OTA center is configured with a serverless architecture have been described in the above embodiment, and thus will be omitted. Further, the module adopting the server architecture is described in, for example, JP 2020-132042 A, and thus the details thereof are omitted.

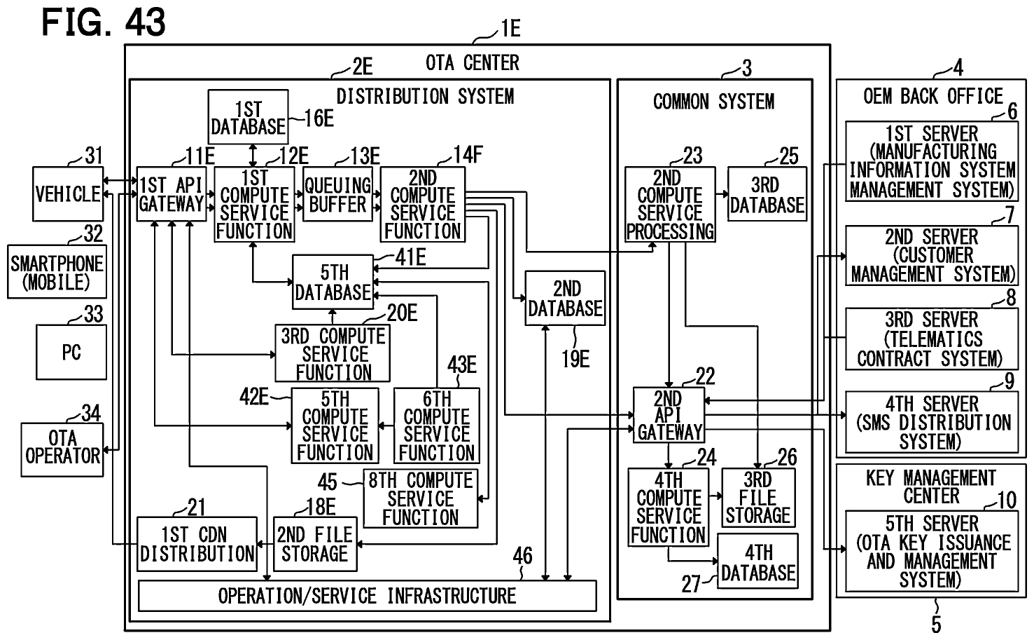

Next, with reference to FIG. 43, the seventh embodiment will be described mainly with respect to differences from the sixth embodiment. The seventh embodiment is different from the sixth embodiment in that the compute service processing section 15E is deleted and integrated into a compute service function section 14F, and an operation/service infrastructure 46 is added as a module adopting a server architecture.

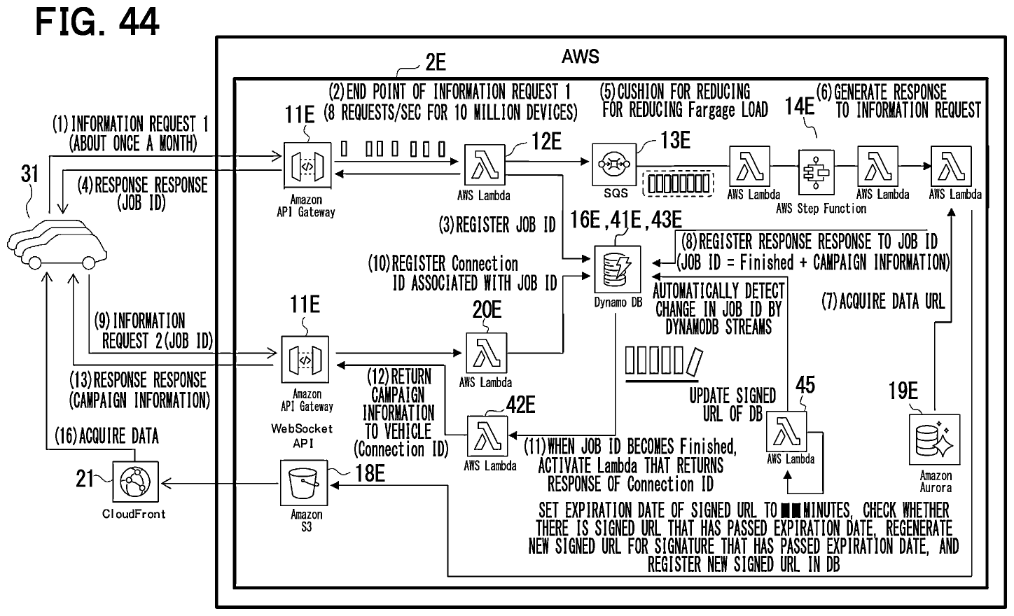

FIG. 44 is an example of a case where a center device 1E illustrated in FIG. 43 is configured using the AWS cloud.

Amazon API Gateway corresponds to the API gateway section 11E.

AWS Lambda corresponds to compute service function sections 12E, 14F, 20E, and 45.

AWS Step Functions corresponds to the compute service function section 14F.

SQS corresponds to the queuing buffer section 13E.

Dynamo DB corresponds to the database sections 16E and 41E and the compute service function section 42E.

In the sixth embodiment, AWS Fargate is provided as the compute service processing section 15E, but in the seventh embodiment, AWS Lambda is provided as the compute service function section 14F.

Next, the operation of the seventh embodiment will be described. In a case where the vehicle, the PC, the smartphone, and the OTA operator request the OTA center, or in a case where the OTA center responds to the vehicle, the PC, the smartphone, and the OTA operator, communication is performed via an API gateway section 11E. In a case where the OEM back office requests the OTA center or in a case where the OTA center returns a response to the OEM back office, communication is performed via the API gateway section 22. In response to the received request, the API gateway section 11E interprets, for example, part of the content of the received information in response to the received request, and determines whether to pass the information to the compute service function section 12E or the operation/service infrastructure 46. Similarly, in response to the received request, the API gateway section 22 interprets, for example, part of the content of the received information and determines a next request destination. The part of the content of the received information is, for example, information indicating a transmission source or information indicating a transmission content.

### <Reception of Vehicle Configuration Information→Transmission of Job ID and Transmission of Campaign Notification Information>

### <Data Access From Vehicle→Transmit Distribution Package From CDN to Vehicle>

These processes are similar to those in the sixth embodiment.

### <Registration of Campaign Information→Registration of Distribution Package to CDN Distribution Section 21>

### <Registration of Case Information→Generation of Package>

### <Reception of Case Information Registration Request→Check of Generation Status of Case Information and Transmission of Case Information>

These processes are interaction between the OTA operator and the OTA center, and are processed by a module adopting a server architecture.

### <Registration of Software Update Data>

This process is interaction between the OEM back office and the OTA center, and is processed by a module adopting a server architecture.

As described above, according to the seventh embodiment, in addition to the effects obtained in the sixth embodiment, it is possible to effectively utilize a developed product such as a program or a module developed on the premise of the server architecture, and at the same time, it is possible to receive an advantage of the serverless architecture. As a result, it is possible to obtain effects such as suppression of the development cost and shortening of the development period.

### Other Embodiments

The application program adopting the serverless architecture is not limited to the one using the AWS, and other cloud computing services may be used.

The information portable terminal is not limited to a smartphone or a personal computer.

The outside with which the OTA center communicates is not limited to the vehicle or the OTA operator.

The access control information is not limited to the expiration date and the signed URL.

Examples of features of the serverless architecture will be described. A serverless architecture is an event-driven architecture in which services are loosely coupled. The loose coupling means that dependency between services is low. Furthermore, the server is stateless, and is required to be designed such that each of the process and the function does not have a state therein. In a serverless architecture, it is necessary to connect requests statelessly from one service to the next. In the serverless architecture, resources are designed to be flexibly changed according to use of a system or a change in load.

In order to design the serverless architecture in this manner, it is necessary to satisfy matters that are not considered in the design of the server architecture. Therefore, a system adopting a serverless architecture cannot be constructed based on a software system configuration, design, specification, and the like assuming a server architecture.

Although the present disclosure has been described according to the embodiments, it is understood that the present disclosure is not limited to the above-described embodiments or structures. The present disclosure incorporates various modifications and variations within the scope of equivalents. Furthermore, various combination and configuration, and other combination and configuration including one, more than one or less than one element may be made in the present disclosure.

Means and/or functions provided by each device or the like may be provided by software recorded in a substantive memory device and a computer that can execute the software, software only, hardware only, or some combination of them. For example, when the control apparatus is provided by an electronic circuit that is hardware, it can be provided by a digital circuit including a large number of logic circuits, or an analog circuit.

The control section and the method thereof of the present disclosure may be implemented by a dedicated computer provided by configuring a processor and a memory programmed to execute one or more functions embodied by a computer program. Alternatively, the control section and the method thereof described in the present disclosure may be implemented by a dedicated computer provided by configuring a processor with one or more dedicated hardware logic circuits. Alternatively, the control section and the method thereof described in the present disclosure may be implemented by one or more dedicated computers configured by a combination of a processor and a memory programmed to execute one or more functions and a processor configured by one or more hardware logic circuits. The computer program may be stored in a non-transitory tangible computer-readable recording medium as an instruction to be executed by a computer.

What is claimed is:

1. A center device that manages data to be written in an electronic control device mounted on a vehicle and performs, by an application program, a plurality of functions for transmitting update data to the vehicle by wireless communication,
wherein
an application program implementing at least one of the functions adopts a server architecture in which a resource is always allocated and that executes as a resident-type process, and
an application program implementing at least one of the other functions adopts a serverless architecture
in which the application program is activated upon occurrence of an event and is dynamically allocated with a resource in an on-demand manner for execution of a code of the application program, and
in which the resource allocated to the application program is released when the execution of the code is terminated, the center device comprising:
a campaign determination section that is configured to receive vehicle configuration information from the vehicle and determine whether there is campaign information for the vehicle;
a campaign generation section that is configured to generate campaign notification information for the vehicle when there is the campaign information;
a status management section that is configured to manage a generation state of the campaign notification information; and
a campaign transmission section that is configured to distribute the campaign notification information to the vehicle according to the generation state,
wherein
the application program that implements functions of the campaign determination section, the status management section, and the campaign generation section adopts the serverless architecture.

2. A center device that manages data to be written in an electronic control device mounted on a vehicle and performs, by an application program, a plurality of functions to transmit update data to the vehicle by wireless communication,
wherein
an application program implementing at least one of the functions adopts a serverless architecture
in which the application program is activated upon occurrence of an event and is dynamically allocated with a resource in an on-demand manner for execution of a code of the application program, and
in which the resource allocated to the application program is released when the execution of the code is terminated, the center device comprising:
a campaign determination section that is configured to receive vehicle configuration information from the vehicle and determine whether there is campaign information for the vehicle;
a campaign generation section that is configured to generate campaign notification information for the vehicle when there is the campaign information;
a status management section that is configured to manage a generation state of the campaign notification information; and
a campaign transmission section that is configured to distribute the campaign notification information to a vehicle according to the generation state,
wherein
an application program that implements functions of the campaign determination section, the status management section, and the campaign generation section adopts the serverless architecture.

3. The center device according to claim 2, wherein
the application program includes:
a first compute service section configured to transfer the vehicle configuration information received from the vehicle via a gateway section to the campaign determination section;
a second compute service section configured to determine, as the campaign determination section and the campaign generation section, whether there is the campaign information for the vehicle based on the vehicle configuration information, and generate the campaign notification information for the vehicle when there is the campaign information; and
a database section configured to manage the generation state of the campaign notification information, and
the first compute service section registers the generation state of the campaign notification information in a database according to content of the vehicle configuration information, and selects and activates the application program included in the second compute service section.

4. The center device according to claim 3, further comprising:
a package distribution section configured to distribute to the vehicle, a package including the update data to be distributed to the vehicle,
wherein
the package distribution section performs distribution by transferring an update package associated with the campaign notification information to a network distribution section, and
an application program that implements a function of the package distribution section adopts the serverless architecture.

5. The center device according to claim 4, wherein
an application program that implements a function of the package distribution section includes a third compute service section configured to transfer the received update package to the network distribution section.

6. The center device according to claim 2, further comprising:
a campaign registration section configured to register vehicle configuration information, campaign information of update data for a vehicle, and update data to be distributed together with the campaign information,
wherein
an application program that implements a function of the campaign registration section adopts the serverless architecture.

7. The center device according to claim 6, wherein
an application program that implements a function of the campaign registration section includes:
a fourth compute service section configured to register the campaign information in a database and register the update data in a file storage section;
a fifth compute service section configured to transfer received campaign information to the fourth compute service section; and
a gateway section configured to transfer campaign information to the fourth compute service section when a request for registration of the campaign information is input by either an operator or a manufacturing information system management system, and
the fourth compute service section selects and activates an application program included in the fifth compute service section according to content of the campaign information.

8. The center device according to claim 7, further comprising
a package generation section configured to generate a package including the update data to be distributed to the vehicle,
wherein
the package generation section processes the received update data into an update package in a format interpretable by a master device that is mounted on a vehicle and transfers to an electronic control device to be updated, and
an application program that implements a function of the package generation section adopts the serverless architecture.

9. The center device according to claim 8, further comprising:
a data management section that is configured to transfer the vehicle configuration information and a corresponding update data that are registered in the file storage section to the package generation section in response to a request from the package generation section,
wherein
an application program that implements a function of the data management section adopts the serverless architecture.

10. The center device according to claim 2, wherein
the status management section assigns a job number for a request received from an outside, and assigns status information indicating whether the request is being processed or the process is completed.

11. The center device according to claim 10, wherein
the campaign transmission section assigns the job number when transmitting a response that is a response to the request to the outside.

12. The center device according to claim 11, wherein
the application program includes a distribution destination management section configured to manage to which outside the campaign notification information is to be distributed, and
an application program that implements a function of the distribution destination management section adopts the serverless architecture.

13. The center device according to claim 12, wherein:
when receiving a request to which the job number is assigned from the outside, the distribution destination management section assigns and registers a connection number associated with the job number;
when there is a request for which processing is completed by referring to a database section, the status management section identifies an outside which is a transmission destination of a response based on the connection number corresponding to the job number of the request; and
the campaign transmission section transmits a response to an identified outside.

14. The center device according to claim 10, wherein
the outside corresponds to an in-vehicle device or an operation person.

15. The center device according to claim 3, wherein
the application program includes a processing capability adjustment section configured to, when checking a processing load of a second compute service section configured to generate the campaign notification information for the vehicle and a total number of pieces of the vehicle configuration information received from the vehicle, determine whether it is necessary to increase or decrease a processing capability of the second compute service section, and increase or decrease the processing capability of the second compute service section as necessary, and
the processing capability adjustment section adopts the serverless architecture.

16. The center device according to claim 2, wherein
the application program includes:
an information control section that includes access control information in information for acquiring an update package associated with the campaign notification information; and
a network distribution section configured to perform access control by confirming that access from a vehicle includes the access control information, and
the information control section and the network distribution section adopt the serverless architecture.

17. The center device according to claim 16, wherein
the information control section checks an expiration state of an expiration date of the access control information, and generates access control information updated to a new expiration date when the access control information is expired.

18. A method of distributing campaign information, the method including managing data to be written to an electronic control device mounted on a vehicle, an application program executing a plurality of functions for transmitting update data to the vehicle by wireless communication,
an application program that implements some functions adopting a server architecture in which a resource is constantly allocated and that is executed as a resident type process,
an application program that implements at least some of other functions being activated in response to occurrence of an event, a resource being dynamically allocated for execution of a code of the application program by an on-demand method,
the application program adopting a serverless architecture in which a resource allocated to the application program is released when execution of the code is completed, the method comprising:
receiving vehicle configuration information from a vehicle and determining whether there is campaign information for the vehicle;
generating campaign notification information for the vehicle when there is the campaign information; and
managing a generation state of the campaign notification information and distributing the campaign notification information to a vehicle according to the generation state, wherein
an application program that implements functions of determination as to whether there is the campaign information, management of a generation state of the campaign notification information, and generation of the campaign notification information adopts the serverless architecture.

19. A method of distributing campaign information, the method including managing data to be written to an electronic control device mounted on a vehicle, an application program executing a plurality of functions for transmitting update data to the vehicle by wireless communication,
an application program that implements at least some functions being activated in response to occurrence of an event, a resource being dynamically allocated for execution of a code of the application program by an on-demand method,
the application program adopting a serverless architecture in which a resource allocated to the application program is released when execution of the code is completed, the method comprising:
receiving vehicle configuration information from a vehicle and determining whether there is campaign information for the vehicle;
generating campaign notification information for the vehicle when there is the campaign information; and
managing a generation state of the campaign notification information and distributing the campaign notification information to a vehicle according to the generation state, wherein
an application program that implements functions of determination as to whether there is the campaign information, management of a generation state of the campaign notification information, and generation of the campaign notification information adopts the serverless architecture.
